(19) United States
(12) Patent Application Publication
(10) Pub. No.: US 2013/0107274 A1
(43) Pub. Date: May 2, 2013

(54) OPTICAL IMAGING AND MAPPING USING PROPAGATION MODES OF LIGHT

(71) Applicant: Tomophase Corporation, Burlington, MA (US)

(72) Inventors: Andrei Vertikov, Westwood, MA (US); Peter E. Norris, Cambridge, MA (US)

(73) Assignee: TOMOPHASE CORPORATION, Burlington, MA (US)

(21) Appl. No.: 13/665,796

(22) Filed: Oct. 31, 2012

Related U.S. Application Data
(60) Provisional application No. 61/553,152, filed on Oct. 28, 2011.

(51) Int. Cl. G01B 9/02

(52) U.S. Cl. 356/479

(57) ABSTRACT

Methods, systems, and devices are disclosed for implementing Doppler optical coherence tomography and microangiography imaging. In one aspect, a device for optically measuring a sample includes a swept light source to produce an input beam of coherent light for optically probing a target area of a sample, a waveguide to guide the input beam in two independent propagation modes, an optical probe to reflect a first propagation mode back to the waveguide and to direct a second propagation mode to the sample and to overlap the reflection from the sample with the first propagation mode, a differential delay controller to produce variable relative phase delays between the first propagation mode and the second propagation mode, a detection module to combine the first propagation mode and the second propagation mode and to extract information of the sample, and a processing unit to process the information to produce optical images.

### PRIORITY CLAIM

This patent document claims the priority of U.S. provisional application No. 61/553,152 entitled “TISSUE MICRO-ANGIOGRAPHY AND OXYGENATION MAPPING USING PROPAGATION MODES OF LIGHT” filed on Oct. 28, 2011, which is incorporated by reference as part of this document.

### TECHNICAL FIELD

This patent document relates to optical coherence tomography (OCT) imaging.

### BACKGROUND

Optical coherence tomography (OCT) is an optical signal acquisition and processing technique that can be used for non-invasive optical probing from within optical scattering media (e.g., such as biological tissue) to reveal their structural, compositional, physiological and biological information to provide tomographic measurements of these substances with micrometer or sub-micrometer resolution in three-dimensional images. OCT is an interferometric technique, e.g., capable of employing near-infrared light. The use of relatively long wavelength light allows it to penetrate into the scattering medium.

For example, in some conventional OCT systems, the light from a light source is split into a sampling beam and a reference beam which propagate in two separate optical paths, respectively. The light source may be partially coherent source. The sampling beam is directed along its own optical path to impinge on the substances under study, or sample, while the reference beam is directed in a separate path towards a reference surface. The beams reflected from the sample and from the reference surface are then brought to overlap with each other to optically interfere. Because of the wavelength-dependent phase delay the interference results in no observable interference fringes unless the two optical path lengths of the sampling and reference beams are very similar. This provides a physical mechanism for ranging. A beam splitter may be used to split the light from the light source and to combine the reflected sampling beam and the reflected reference beam for detection at an optical detector. This use of the same device for both splitting and recombining the radiation is essentially based on the well-known Michelson interferometer.

Optical coherence tomography imaging includes distinct modalities: time domain OCT (TD-OCT), frequency domain OCT (FD-OCT), which is also known as swept source OCT (SS-OCT) or optical frequency domain imaging (OFDI) that uses a wavelength-swept light, and spectral domain OCT (SD-OCT). All three types of OCT imaging can probe the amplitude, phase, polarization and spectral properties of back scattering light from the tissue. For some applications, FD-OCT and SD-OCT can offer intrinsic signal-to-noise ratio (SNR) advantages over the time domain techniques because the interference signal can be effectively integrated through a Fourier transform enabling significant improvements in imaging speed, sensitivity and ranging depth, e.g., often required for in vivo tissue imaging.

### SUMMARY

Techniques, systems, and devices are described for implementing OCT in measuring and imaging samples such as tissues, including Doppler OCT and microangiography imaging.

In one aspect of the disclosed technology, a device for optically measuring a sample includes a swept light source to produce an input beam for optically probing a target area of a sample by sweeping an optical wavelength of the swept light source; a waveguide having a proximal end to receive the input beam from the swept light source and a distal end towards which the received input beam is guided by the waveguide in two independent propagation modes propagating with different polarization states; an optical probe coupled to the distal end of the waveguide to receive the input beam and to reflect a first portion of the input beam corresponding to a first propagation mode back to the waveguide and direct a second portion of the input beam corresponding to a second propagation mode to the sample, the optical probe configured to overlap reflection of the second portion from the sample with the first portion and to export to the waveguide the reflection as a reflected second portion; a differential delay controller to receive light returned from the optical probe via the waveguide including the first portion and the reflected second portion, the differential delay controller operable to split the received light into a first beam corresponding to the first portion and a second beam corresponding to the reflected second portion and to produce variable relative phase delays between the first beam and the second beam; a detection module to combine the first beam and the second beam that is outputted by the differential delay controller, the detection module operable to extract information of the sample carried by the reflected second portion at different depths in the sample based on the variable relative phase delays produced by the differential delay controller, and convert the extracted information to an electronic signal; and a processing unit to process the electronic signal to produce optical images of the target area of the sample at different depths from a surface of the target area, and the processing unit configured to synchronize sweeping of the optical wavelength of the swept light source with the optical probe and detection module.

Implementations of the device can optionally include one or more of the following features. The optical images can include data including an oxygen exchange state in blood present at the target area to produce a map of blood oxygenation or blood flow within the target area. The swept light source can include a wavelength tunable coherent laser. The waveguide can include a polarization maintaining (PM) fiber. The device can further include a light propagation mode director component coupled to the distal end of the waveguide and structured to include a polarization-maintaining optical circulator and three ports, the polarization-maintaining optical circulator to optically route the independent propagation modes of the input beam from a first port to a second port and optically route reflected light received at the second port to a third port, a second waveguide having a proximal end to receive the independent propagation modes of the input beam from the second port and a distal end coupled to the optical probe towards which the independent propagation modes are guided by the second waveguide, and a third waveguide having a proximal end to receive the reflected light from the third port and a distal end coupled to the differential delay controller to which the independent propagation modes are guided by the third waveguide. The device can further include a mode controller configured as an inline polarization controller along the waveguide that allows dynamic control of the relationship between amplitude and phase of the independent propagation modes of the input beam. The optical probe of the device can include a sheath structured to include a hollow channel along a sheath longitudinal direction, the sheath having a proximal end coupled to the distal end of the waveguide and configured to receive the input beam and a distal end configured to export the second portion of the input beam as probe light outside the sheath to the sample; a polarization maintaining (PM) fiber movably placed inside the hollow channel of the sheath and structured to exhibit a first principal polarization direction and a second, orthogonal principal polarization direction, both substantially perpendicular to a longitudinal direction of the PM fiber; an optical probe head located inside the sheath and engaged to a distal end of the PM fiber with a fixed orientation relative to the first principal polarization axis of the PM fiber to receive the input beam from the PM fiber, the optical probe head including an optical mode converter component to convert the probe light from one propagation mode to another such that back-scattered light collected by the optical probe head propagates back in the device in different propagation modes, and a light directing element including a prism to direct the probe light at an angle relative to a rotational axis of the optical probe head, in which the optical probe head directs the probe light polarized in the first principal polarization direction to exit the optical probe head at a first exit angle with respect to the sheath longitudinal direction and the probe light polarized in the second principal polarization direction to exit the optical probe head at a second, different exit angle with respect to the sheath longitudinal direction, respectively; and a rotation mechanism coupled to the optical probe head and operable to rotate the optical probe head inside the sheath about the sheath longitudinal direction to change a direction of light existing the optical probe head at the first exit angle and at the second exit angle. The optical probe head can further include one or more lenses to receive light from the PM fiber and focus at least a fraction of the probe light onto the target area and collects the back-scattered light. The optical mode converter component can be configured as at least one of a waveplate, one or more prisms providing retardation, a 45 degree Faraday rotator, an achromatic mode converter utilizing two polarization rotators and two linear retarders, or an achromatic mode converter utilizing two polarization rotators and one linear retarder. The differential delay controller can include a beam splitter to separate the light returned from the optical probe via the waveguide into the first beam corresponding to the first portion along a first optical path and the second beam corresponding to the reflected second portion along a second optical path, a variable optical delay element in one of the first and the second optical paths to cause the relative phase delays between the first light beam and the second light beam, and a beam combiner to combine the first beam and the second beam to produce combined light. The detection module can include a polarization beamsplitter to combine the independent propagation modes corresponding to the first and the second beams as a mixed optical signal, and a balanced optical receiver including a plurality of optical detectors and subtraction, filtering, or amplification circuitry to convert the mixed optical signal to the electronic signal.

In another aspect of the disclosed technology, a device for optically measuring a sample includes a broadband light source to produce an input beam of light for optically probing a target area of a sample; a waveguide having a proximal end to receive the input beam from the broadband light source and a distal end towards which the received input beam is guided by the waveguide in two independent propagation modes propagating with different polarization states; an optical probe coupled to the distal end of the waveguide to receive the input beam and to reflect a first portion of the input beam corresponding to a first propagation mode of the light back to the waveguide and direct a second portion of the input beam corresponding to a second propagation mode of the light to the sample, the optical probe configured to overlap reflection of the second portion from the sample with the first portion and to export to the waveguide the reflection as a reflected second portion; a differential delay controller to receive light returned from the optical probe via the waveguide including the first portion and the reflected second portion, the differential delay controller operable to split the received light into a first beam corresponding to the first portion and a second beam corresponding to the reflected second portion and to produce variable relative phase delays between the first beam and the second beam; a detection module to combine the first beam and the second beam that is outputted by the differential delay controller, the detection module operable to extract information of the sample carried by the reflected second portion at different depths in the sample based on the variable relative phase delays produced by the differential delay controller, and convert the extracted information to an electronic signal; and a processing unit to process the electronic signal to produce optical images of the target area of the sample at different depths from a surface of the target area, and the processing unit configured to synchronize the optical probe and detection module.

The subject matter described in this patent document can be implemented in specific ways that provide one or more of the following features. The disclosed technology can enable the screening of early stage lung cancer, particularly among those in high risk populations, and significantly reducing the degree of ‘overtreatment’, e.g., such as therapies and/or surgeries performed on non-life threatening (non-vascularized) tumors or nodules, by focusing the physicians attention on vascularized ones. The disclosed technology can be implemented to produce high resolution images inside tubular or other structures, e.g., such as blood vessels, airways of the bronchial tree of the lungs, the gastrointestinal tract, the genital tract or the urinary tract, etc., through an endoscope or other type probe despite the uncontrolled environment of voluntary and involuntary motion of the probe and/or tissue, thereby demonstrating immunity to endoscope motion and/or environmental perturbations.

### BRIEF DESCRIPTION OF THE DRAWINGS

FIG. 1A shows an exemplary optical sensing device of the disclosed technology.

FIG. 1B shows a schematic of an exemplary mode director for the exemplary optical sensing device shown in FIG. 1A.

FIG. 2 shows a schematic of an exemplary drive unit of an optical probe of the exemplary optical sensing device.

FIGS. 3A and 3B show exemplary achromatic ½ wavelength retarders implemented in an exemplary polarization maintaining optical rotary joint.

FIG. 4A shows an exemplary polarization maintaining optical rotary joint utilizing ¼ waveplates.

FIG. 4B shows an exemplary optical rotary joint utilizing dynamic state of polarization control.

FIGS. 5A and 5B show exemplary achromatic ¼ wavelength retarders implemented in an exemplary polarization maintaining optical rotary joint.

FIGS. 6A and 6B show schematics of the distal end and proximal end, respectively, of an exemplary disposable optical probe.

FIGS. 7A-7F show configurations of an exemplary optical probe structure with mode converters.

FIGS. 8A-8C show configurations of an exemplary differential delay controller.

FIG. 8D shows a schematic of an exemplary detection subsystem.

FIG. 9A shows a block diagram of an exemplary controls and signal processing subsystem.

FIGS. 9B and 9C show process diagrams of exemplary operation techniques of a controls and signal processing subsystem.

FIG. 9D shows an exemplary alternative signal processing for flow sensitivity (using different section of one A-line).

FIG. 10A shows another exemplary optical sensing device of the disclosed technology.

FIG. 10B shows a schematic of an exemplary probe with selective mode converter component for the exemplary optical sensing device shown in FIG. 10A.

FIG. 11A shows another exemplary optical sensing device of the disclosed technology, e.g., which includes the probe with mode converter and broadband source.

FIG. 11B shows a diagram of the arrangement of an exemplary detection subsystem for the optical sensing device shown in FIG. 11A.

FIG. 12 shows other exemplary optical sensing device of the disclosed technology.

Like reference symbols and designations in the various drawings indicate like elements.

### DETAILED DESCRIPTION

Energy in light traveling in an optical path such as through an optical waveguide may be in different propagation modes. Different propagation modes may be in various forms. States of optical polarization of light are examples of such propagation modes. Two independent propagation modes do not mix with one another in the absence of a coupling mechanism. As an example, two orthogonally polarization modes do not interact with each other even though the two modes propagate along the same optical path or waveguide and are spatially overlap with each other.

In various examples described in this patent document, optical radiation in performing optical coherence tomography (OCT) is not physically separated to travel different optical paths in sensing or imaging a sample such as a tissue. Instead, all propagation waves and modes are guided along essentially the same optical path through one or more common optical waveguides. Such designs with the common optical path may be advantageously used to stabilize the relative phase among different radiation waves and modes in the presence of environmental fluctuations in the system such as variations in temperatures, physical movements of the system especially of the waveguides, and vibrations and acoustic impacts to the waveguides and system. In this and other aspects, the present systems are designed to do away with the two-beam-path configurations in various interferometer-based systems in which sample light and reference light travel in different optical paths in part to significantly reduce the above fluctuation and drift in the differential phase delay. Therefore, the present systems have a “built-in” stability of the differential optical path by virtue of their optical designs and are beneficial for some phase-sensitive measurement, such as the determination of the absolute reflection phase and birefringence. In addition, the techniques, systems, and devices described in this patent document simplify the structures and the optical configurations of devices for optical probing by using the common optical path to guide light.

Two independent propagation modes in light in the same optical path or waveguide can be used to measure optical properties of a sample, as described in U.S. Pat. No. 7,456,965 entitled “OPTICAL MEASUREMENTS OF PROPERTIES IN SUBSTANCES USING PROPAGATION MODES OF LIGHT”, which is incorporated by reference in its entirety as part of the disclosure of this patent document. In some implementations of the an exemplary embodiment described in the incorporated reference, a probe head may be used to direct the light to the sample, either in two propagation modes or in a single propagation modes, and receive the reflected or back-scattered light from the sample, which can be used to produce an image of the sample. For example, one beam of guided light in a first propagation mode may be directed to a sample. A first portion of the first propagation mode may be arranged to be reflected before reaching the sample while the a second portion in the first propagation mode is allowed to reach the sample. The reflection of the second portion from the sample is controlled in a second propagation mode different from the first propagation mode to produce a reflected second portion. Both the reflected first portion in the first propagation mode and the reflected second portion in the second propagation mode are directed through a common waveguide into a detection module to extract information from the reflected second portion on the sample, e.g., such as biological tissue, extracting structural, compositional, physiological and/or biological information to provide a tomographic measurement and/or image. In another exemplary implementation, optical radiation in both a first propagation mode and a second but different propagation mode may be guided through an optical waveguide towards a sample. The radiation in the first propagation mode is directed away from the sample without reaching the sample. The radiation in the second propagation mode is directed to interact with the sample to produce returned radiation from the interaction. Both the returned radiation in the second propagation mode and the radiation in the first propagation mode are coupled into the optical waveguide away from the sample. The returned radiation in the second propagation mode and the radiation in the first propagation mode from the optical waveguide are then used to extract information of the sample, e.g., such as biological tissue, extracting structural, compositional, physiological and/or biological information to provide a tomographic measurement and/or image. In these and other implementations, two independent modes are confined to travel in the same waveguides or the same optical path in free space except for the extra distance traveled by the probing light between the probe head and the sample. This feature stabilizes the relative phase, or differential optical path, between the two modes of light, even in the presence of mechanical movement of the waveguides. This is in contrast to conventional interferometer sensing devices, in which sample light and reference light travel in different optical paths. These interferometer sensing devices with separate optical paths are prone to noise caused by the variation in the differential optical path, generally complex in optical configurations, and difficult to operate and implement. The examples described below based on waveguides are in part designed to overcome these and other limitations.

Light can be guided through an optical waveguide (e.g., such as optic fiber) to a target to obtain optical images, optical measurements and other operations of the target. For example, the tissue of an internal organ of a patient may be made available for a medical examination or therapy procedure through a natural orifice or an incision to expose the internal organ. Such a procedure may be performed by delivering probe light to the tissue via an endoscope instrument or catheter to reduce or minimize the degree of invasiveness. At the distal end of the instrument, light is pointed to certain direction or steered to interact with an area or a slice of tissue of interest. Delivery of light via an optical waveguide can be implemented to perform various procedures, such as medical imaging, diffuse-reflection spectroscopy, fluorescence spectroscopy, coherence-gated optical tomography, photodynamic therapy, laser hyperthermia and others.

Optical frequency domain imaging (OFDI) or frequency domain optical coherence tomography (FD-OCT) can be applied for in vivo non-invasive cross-sectional imaging of tissue with microscopic resolution for diagnostics and image-guided therapy. Yet, for determining tissue structure with high resolution, there is a need for high resolution functional imaging of blood flow as well as blood oxygenation for the purpose of microangiography. Tumors often need to constantly renew their blood supply as they grow, which can occur through a physiological process involving the growth of new blood vessels from pre-existing vessels referred to as angiogenesis. For example, the study of pathological angiogenesis on a microscopic scale may enable early cancer diagnosis as well as better control of cancer therapy. Conventional techniques using Doppler imaging modalities, e.g., such as Doppler ultrasound, do not produce sufficient spatial resolution and thus lack sufficient sensitivity to early phases of pathological angiogenesis. For example, in contrast to late stage lung cancer (LSLC), which is very often fatal (e.g., 5 year survival of only 15%), early stage lung cancer (ESLC) is curable (e.g., 5 year survival of 85%). Because ESLC is asymptomatic, it is rarely diagnosed, except by accident, e.g., such as a consequence of a chest CT scan for an injury. Yet, one of the primary indicators of cancer malignancy would then be the presence of this neo-vascular bundle (NVB) of capillaries present around the periphery of a tumor. One approach to imaging the NVB indicator is the use of Doppler OCT, which is sensitive to the motion of red blood cells within the NVB as a consequence of blood flow. For example, physiological blood flow velocities range from 10⁻⁶ to 10⁻² m/s in the microcirculatory circuits (e.g., including capillaries, arterioles and venules) and can reach >1 m/s in the major vessels.

In Doppler imaging applications, including Doppler OCT, the motion of an endoscope or other types of probes and the movements of internal components of the probe, e.g., such as bending, twisting and internal fiber rotation, can adversely affect the sensitivity of imaging because the signal and reference light may experience different polarization changes. To mitigate this problem, some conventional methods have used polarization diversity detection techniques, which unfortunately can make the detection subsystems of the imaging apparatuses complicated and expensive. Additionally, some conventional endoscopic-based devices and techniques using OCT for Doppler imaging suffer from phase instabilities, e.g., due to motion of the endoscope, in which the quality of Doppler imaging that relies on analysis of the phases of back-scattered light can be degraded severely by such phase instabilities. Also, for example, clinical applications of conventional Doppler imaging devices may experience difficulty of interchanging disposable parts of the catheters. This may be because the reference and the signal paths are separated optical paths and thus need to be accurately matched and therefore either disposable part needs to be assembled to very high tolerances or there must be means to automatically compensate for disposable length variations, further complicating the Doppler imaging device designs. Thus, there is a need for Doppler imaging apparatuses that are immune to endoscope and/or endoscope component motion and environmental perturbations (e.g., in body lumens, and that allows easily interchangeable disposable parts.

Techniques, systems, and devices are described in this patent document for implementing Doppler OCT imaging, e.g., which can be deployed in the pulmonary airways and parenchyma to detect the presence of NVB at the periphery of solitary pulmonary nodules, thereby providing a strongly predictive indicator of a malignancy.

The disclosed Doppler OCT technology can be implemented in ways that enable ESLC screening, particular in among those considered as high risk populations, and significantly reducing the degree of ‘overtreatment’, e.g., such as therapies and/or surgeries performed on non-life threatening (non-vascularized) tumors or nodules, by focusing the physicians attention on vascularized ones. For example, overtreatment is a primary criticism of ESLC screening in terms of excessive, unjustified risk and cost. The disclosed Doppler OCT technology can be implemented to produce high resolution images inside tubular or other structures, e.g., such as blood vessels, airways of the bronchial tree of the lungs, the gastrointestinal tract, the genital tract or the urinary tract, etc., through an endoscope or other type probe despite the uncontrolled environment of voluntary and involuntary motion of the probe and/or tissue, thereby demonstrating immunity to endoscope motion and/or environmental perturbations.

In addition to analysis of blood flow and microangiography, there is a need for high resolution and higher throughput imaging of blood oxygenation. The disclosed Doppler OCT imaging technology includes methods that improve the sensitivity and imaging speed of techniques to map physiological functions of tissues in lungs and other organs, as described in U.S. Pat. No. 7,831,298 entitled “MAPPING PHYSIOLOGICAL FUNCTIONS OF TISSUES IN LUNGS AND OTHER ORGANS”, which is incorporated by reference in its entirety as part of the disclosure of this patent document. For example, disclosed are techniques for mapping blood oxygenation and apply such mapping for cancer diagnostics and treatment applications that augment the techniques described in U.S. Pat. No. 7,831,298 to accommodate Fourier transform processing steps to increase signal integration times and thus increasing signal-to-noise ratios.

The disclosed techniques, systems, and devices include the use of different propagation modes of a multi-mode waveguide for optical imaging, e.g., including Doppler OCT imaging and microangiography. Various features disclosed in U.S. Pat. No. 7,456,965 and U.S. Pat. No. 7,831,298 can be implemented in the presently disclosed technology. In the described implementations of the present Doppler or microangiography imaging technology, (1) a broadband light source can be replaced with a swept light source for some embodiments and a balanced receiver of a detector subsystem can be replaced with grating and array detector for other embodiments; (2) modifications to subsystems and components that accommodate the implementation of the swept light source are made; (3) a new embodiment of an optical probe, e.g. including a drive unit and disposable catheter is disclosed, as well as signal processing and image processing steps; and (4) signal processing techniques that results in simultaneous structural and Doppler images (e.g., based on Kasai autocorrelation function estimator) are disclosed. Also, in the described implementations for Doppler or microangiography imaging, spectral imaging methods disclosed in U.S. Pat. No. 7,831,298 are included in the implementations to all of the disclosed embodiments of the Doppler or microangiography imaging of the present technology.

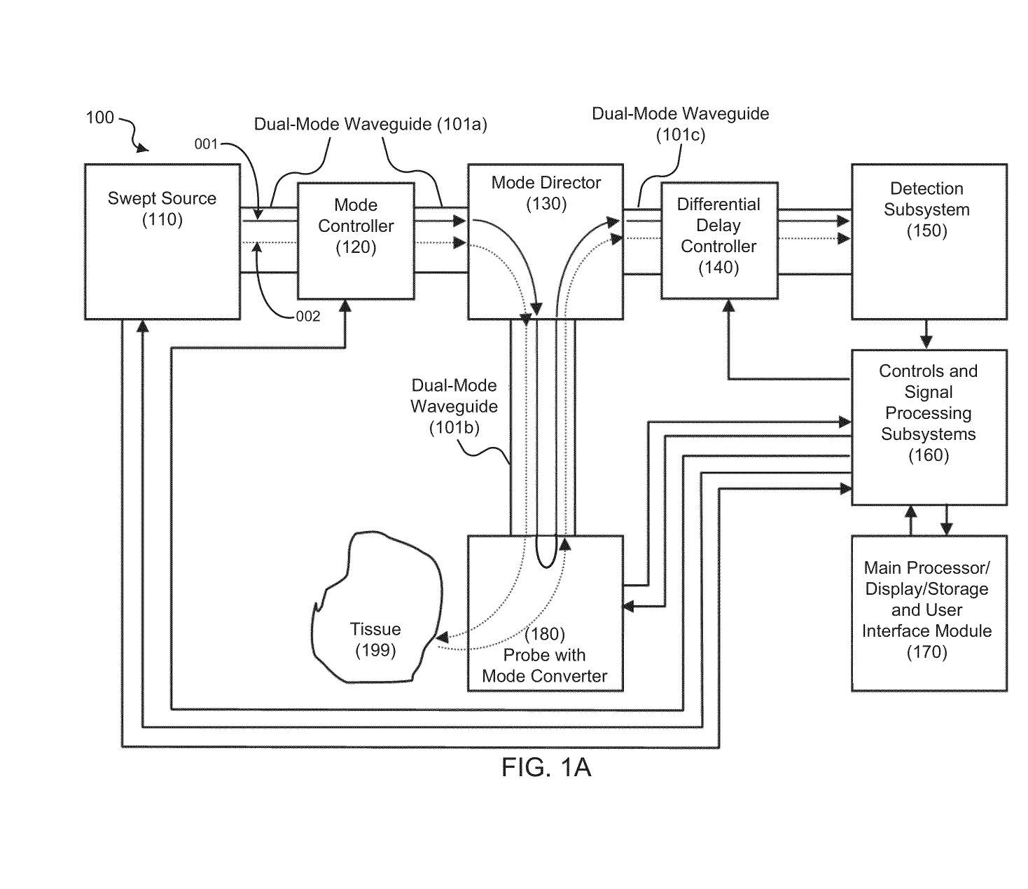

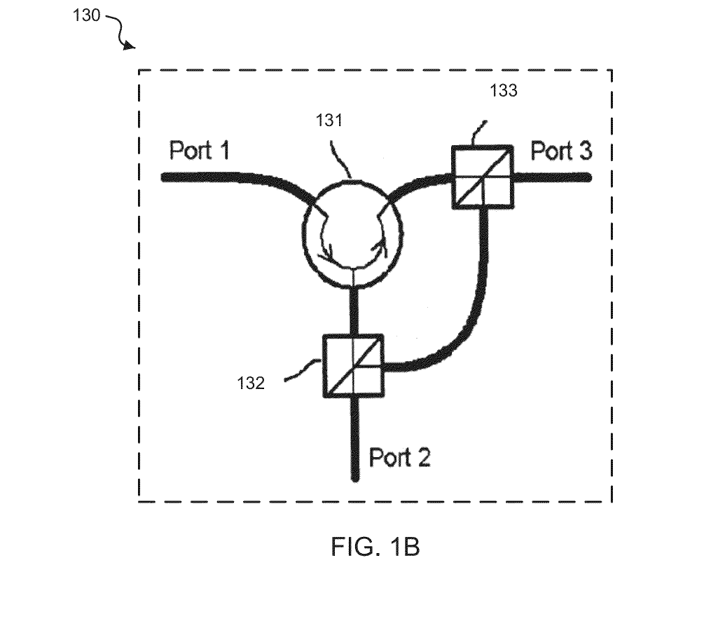

FIG. 1A shows an exemplary embodiment of an optical sensing device 100 of the disclosed technology that can be implemented to perform Doppler OCT imaging, e.g., including blood flow and blood oxygenation mapping and microangiography. The device 100 can be implemented to direct light in two propagation modes along the same multi-mode waveguide (e.g., such as dual-mode waveguide 101) to an optical probe with mode converter 180 that can be positioned at or near a target, e.g., tissue sample 199, for acquiring information of optical inhomogeneity in the sample. The dual-mode waveguide 101 can include at least one piece of polarization maintaining (PM) fiber that supports two propagation modes with different polarization states, in which the propagation mode includes different propagation constants. Light radiation from a swept source 110 (e.g., such as a wavelength tunable coherent laser) is coupled into the dual-mode waveguide 101 to excite two orthogonal propagation modes 001 and 002. The light by the swept source 110 propagates through a first dual-mode waveguide 101a to a mode director 130 coupled to the dual-mode waveguide 101 with a mode controller 120 configured along the optical path. For example, the light propagates from the swept source 110 to the mode controller 120 through the first section of the first dual-mode waveguide 101a and to the mode director 130 through the second section of the first dual-mode waveguide 101a. The mode director 130 is used to direct the two propagation modes 001 and 002 to a second dual-mode waveguide 101b that is terminated by the probe with mode converter 180.

The probe with mode converter 180 can include a drive unit and an imaging catheter unit, which can be configured as a disposable catheter, both described later. The probe with mode converter 180 may be configured to perform at least the following functions. The probe with mode converter 180 can reverse the propagation direction of a portion of light in the second dual-mode waveguide 101b in at least one of the propagation modes (e.g., in the propagation mode 001), reshape and deliver the remaining portion of the light in the other propagation mode (e.g., in the propagation mode 002) to the tissue sample 199, and collect the light reflected from the tissue sample 199 back to the second dual-mode waveguide 101b. The back traveling light in both modes 001 and 002 is then directed by the mode director 130 to a third dual-mode waveguide 101c and other subsequent multi-mode waveguides, in which the light further propagates towards a differential delay controller 140. The differential delay controller 140 is capable of varying the relative optical path length and optical phase between the two modes 001 and 002. A detection subsystem 150 is used to superpose the two propagation modes 001 and 002 to form two new modes, mutually orthogonal, to be received by photo-detectors, e.g., in which each new mode is a mixture of the modes 001 and 002. The superposition of the two modes 001 and 002 in the detection subsystem 150 allows for a range detection. For example, the light entering the detection subsystem 150 in the mode 002 is reflected by the sample, bearing information about the optical inhomogeneity of the tissue 199, while the other mode 001 bypassing the tissue 199 inside probe with mode converter 180. So long as these two propagation modes 001 and 002 remain independent through the dual-mode waveguides 101, their superposition in the detection subsystem 150 may be used to obtain information about the tissue 199 without the separate optical paths used in some conventional Michelson interferometer systems.

The optical sensing device 100 includes a controls and signal processing subsystem 160 that is in communication with the swept source 110, the mode controller 120, the probe with mode converter 180, the differential delay controller 140, the detection subsystem 150, and a main processor/display/storage and user interface module 170 of the optical sensing device 100. The controls and signal processing subsystem 160 can be used to synchronize the swept source wavelength tuning of the swept source 110 and control other modules of the optical sensing device 100, e.g., including the probe with mode converter 180 and the detection subsystem 160, as described later in the patent document. The controls and signal processing subsystem 160 can include a processing unit to process the electrical signal. The processing unit can include, at least, a processor and a memory coupled to the processor. For example, the memory may encode one or more programs that cause the processor to perform one or more of the method acts described in this patent document. For example, the processing unit can be implemented to process digital electronic signals representing the optical information of the tissue sample 199, e.g., which can be used to produce optical images of a target area of the tissue 199 at different depths from a surface of the target area, e.g., including Doppler OCT and microangiography images. In some examples, the optical images include data on an oxygen exchange state in blood present at the target area to produce a map of the oxygen exchange state in blood at different depths at each location where the light enters the target area.

The swept source 110 outputs wavelength tunable light, and may also output control (electrical) signals such as sweep trigger pulses and k-clock pulses, which can include clock signals representing equi-spaced wavenumbers used to monitor the output frequency of the swept source 110. For example, some of the electrical signals including the k-clock pulses are received by the controls and signal processing subsystem 160 for synchronization. The swept source 110 can also receive and accept control signals from the main processor/display/storage and user interface module 170, e.g., via the controls and signal processing subsystem 160, for turning laser power on/off and perform power value adjustments and other functions. The main processor/display/storage and user interface module 170 can be configured as a stand-alone or embedded computer system and display monitor and can include devices to obtain user inputs, e.g., including, but not limited to, keyboards, keypads, mouse, foot pad, etc.

The mode controller 120 can be configured as an inline polarization controller that allows dynamic control of the amplitude and phase relationship between the two propagation modes 001 and 002. For example, the mode controller 120 can include the inline polarization controller Model PCD-M02-B from General Photonics. In some implementations, the mode controller 120 can also be configured between the mode director 130 and the probe with mode converter 180, and additionally or alternatively the mode controller 120 can be configured between the mode director 130 and the detection subsystem 150. The mode controller 120 converts the source state of polarization (SOP) into required SOP and dynamically compensates source SOP drift and SOP effects of the optical rotary joints, as discussed later in the patent document. In some implementations, the mode controller 120 may also incorporate a phase modulator to modulate the optical phase of light in one propagation mode relative to the other.

In some exemplary implementations, the mode director 130 can be configured as a polarization insensitive circulator. For example, the mode director 130 can include OCT compatible circulators from Thorlabs. For example, the polarization insensitive circulator can be operated as a passive, polarization-independent, three-port propagation mode director device that acts as an optical signal router. The exemplary polarization insensitive circulator can function in the following manner. Light coupled into a first port (port 1) from the input fiber dual-mode waveguide 101a can be directed to the output fiber dual-mode waveguide 101b via the second port (port 2), but light returning through the output fiber dual-mode waveguide 101b coupled into the exemplary polarization insensitive circulator through port 2 becomes redirected to a third port (port 3) with virtually no loss, e.g. in which the third port is coupled to the dual-mode waveguide 101c. Light input into port 1 will not be coupled into the port 3-coupled fiber (e.g., dual-mode waveguide 101c), and light input into port 2 will not be coupled into the port 1-coupled fiber (e.g., dual-mode waveguide 101a).

FIG. 1B shows another exemplary embodiment of the mode director 130 including a polarization-maintaining optical circulator 131 and two polarization beam splitters 132 and 133, in which the PM optical circulator 131 is used to convey only one polarization mode among its three ports, as described in U.S. Pat. No. 6,943,881 entitled “MEASUREMENTS OF OPTICAL INHOMOGENEITY AND OTHER PROPERTIES IN SUBSTANCES USING PROPAGATION MODES OF LIGHT”, which is incorporated by reference in its entirety as part of the disclosure of this patent document. The polarizing beam splitters 132 and 133 are coupled to PM optical circulator 131 so that both polarization modes entering Port 2 are conveyed to Port 3 and remain independent.

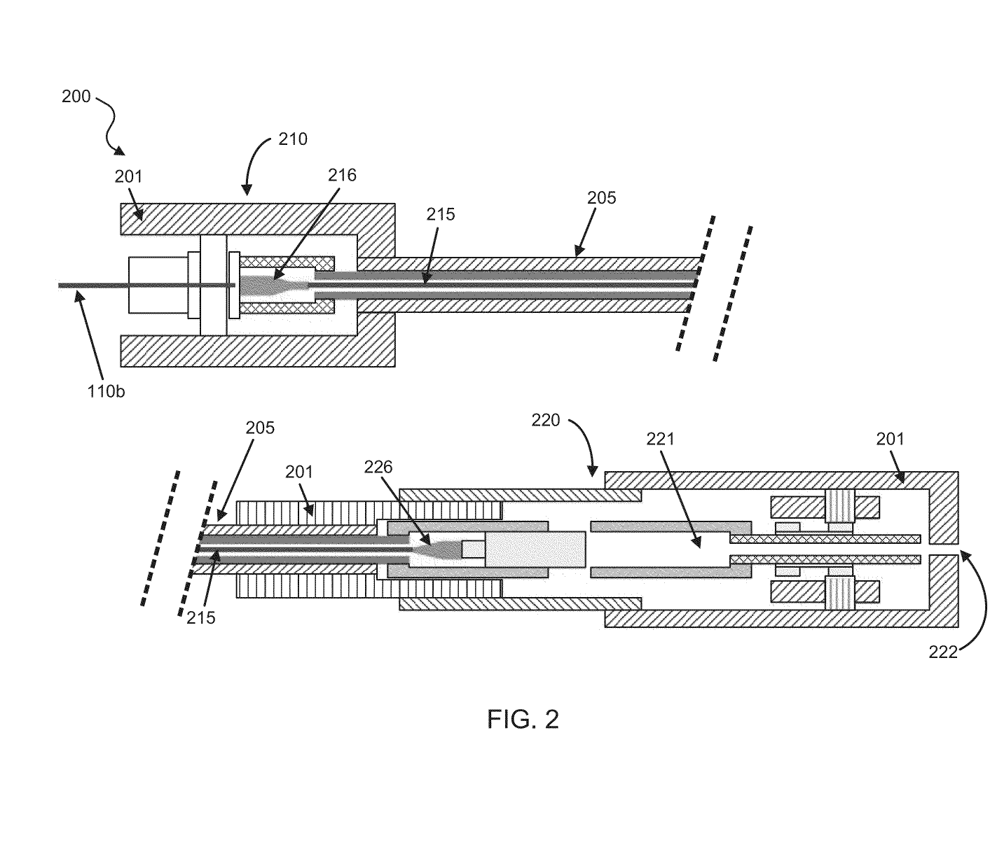

The probe with mode converter 180 is coupled to the distal end of the waveguide to receive the input beam of coherent light and to reflect a first portion of the input beam corresponding to the propagation mode 001 of the coherent light back to the dual-mode waveguide 101b and direct a second portion of the input beam corresponding to the propagation mode 002 of the coherent light to the tissue sample 199. The probe with mode converter 180 is configured to overlap The reflection of the propagation mode 002 from the sample 199 with the propagation mode 001 and to export to the dual-mode waveguide 101b the reflection as a reflected second portion of the coherent light. The probe with mode converter 180 can include a drive unit and an imaging catheter unit. FIG. 2 shows a schematic of a drive unit 200 of the probe with mode converter 180. The drive unit 200 includes an optical rotary joint (ORJ) 210 and a rotary drive 220. In some implementations, the ORJ 210 and the rotary drive 220 can be housed in a housing 201 of the drive unit 200. The ORJ 210 can be optically connected at its stator end to the mode director 130. An optical fiber 215 of the optical rotary joint can be attached to the rotor side of the ORJ 210 by a standard optical connector 216, e.g., such as a fixed connector (FC), subscriber connector (SC), or any small form factor connector. The ORJ 210 can be mechanically connected on the rotor side to the rotary drive 220 via a hollow flexible shaft 205, with the optical fiber 215 of the optical rotary joint contained inside the hollow flexible shaft 205. The rotary drive 220 can be configured as a direct-drive DC or stepper motor with a hollow shaft 221 or a hollow shaft in a single or double bearing driven via gear or belt mechanisms. For example, a bore 222 of the hollow shaft 221 is configured to be large enough so that the entire structure of the imaging catheter unit (e.g., disposable catheter) can be inserted at least from one end into the rotary drive 220. The rotary drive 220 is structured to engage and disengage the coupling of the hollow flexible shaft 205 so that the probe with mode converter 180 can be easily connected and disconnected. For example, the rotary drive 220 can include a collet-type or keyed coupling or any other type coupling that transfers torque from the rotary drive 220 to the internal flexible shaft of the exemplary disposable catheter. The rotary drive 220 is also structured to connect the outer sheath of the exemplary disposable catheter to the housing 201 of the drive unit 200.

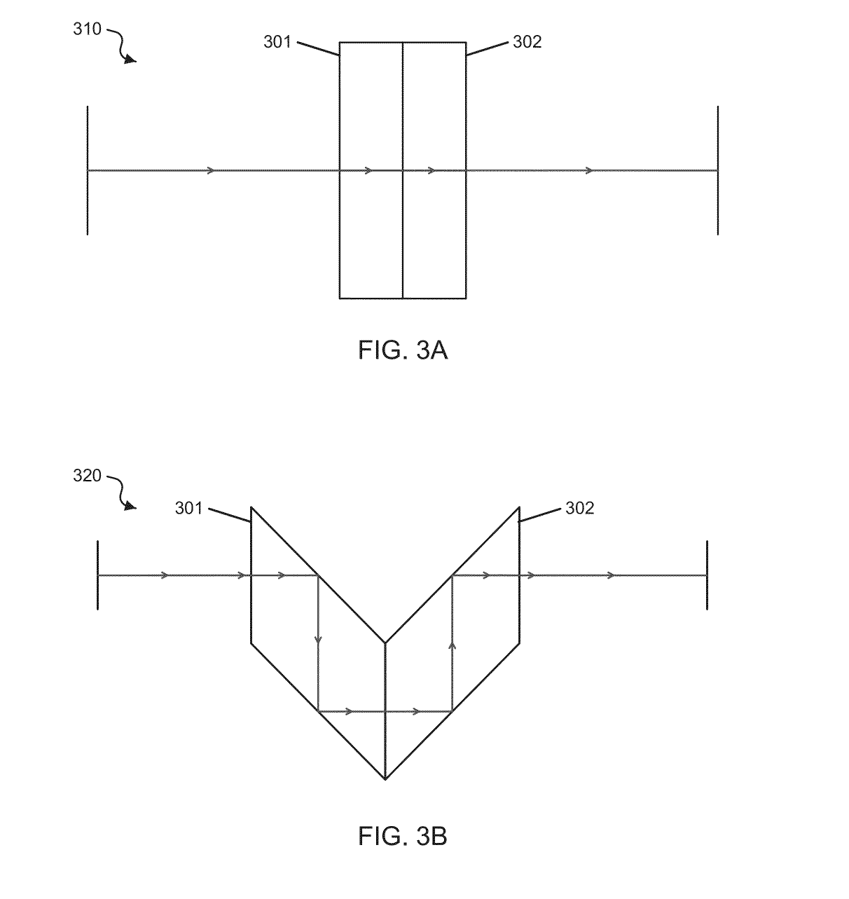

For operation with polarization maintaining (PM) fibers, e.g., such as the dual-mode waveguide, the optical rotary joint 210 needs to maintain polarization. For example, one type of polarization maintaining optical rotary joints that can be employed in the exemplary drive unit 200 is described in U.S. Pat. No. 4,848,867 entitled “ROTARY JOINT FOR POLARIZATION PLANE MAINTAINING OPTICAL FIBERS”, which is incorporated by reference in its entirety as part of the disclosure of this patent document. An exemplary PM ORJ that can be implemented as the ORJ 210 of the drive unit 200 in the disclosed technology can include a rotary member, a fixed member, two optical fiber collimators and a ½ wavelength plate for coupling a PM fiber connected to the rotary member with another PM fiber connected to the fixed member, and gears for rotating the ½ wavelength plate with a speed equal to half the rotational speed of the PM fiber of the rotary member side. The ½ wavelength plate needs to be substantially achromatic in the region of the wavelength tuning of the swept source 110. For example, standard zero order ½ waveplates made, for example, from quartz can be used for this purpose. The other two types of achromatic ½ wavelength retarders that can be suitable for OFDI applications of the exemplary PM ORJ are shown in FIGS. 3A and 3B. FIG. 3A shows an achromatic ½ wavelength retarder 310 and FIG. 3B shows an achromatic ½ wavelength retarder 320 with a compound waveplate design, including two waveplates of different materials 301 and 302, e.g., such as quartz and MgF₂. FIG. 3B shows the compound waveplate 320 with standard Fresnel rhombs that rely on total internal reflection to produce required ½ wavelength retardation.

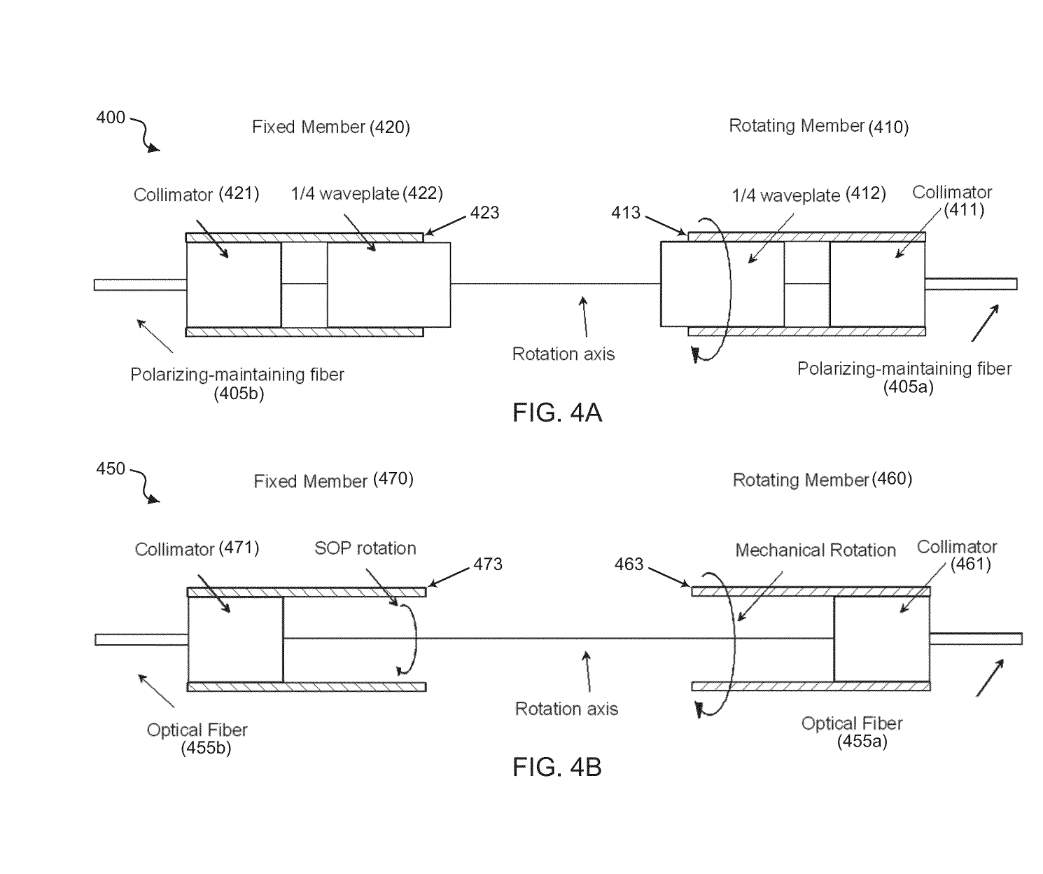

In another example, a polarization maintaining optical rotary joints that can be employed in the exemplary drive unit 200 is shown in FIG. 4A. A PM ORJ 400 shown in FIG. 4A includes a rotary member 410 capable of rotating about a fixed member 420, in which the rotary member 410 and the fixed member 420 are coupled to polarizing-maintaining fibers 405a and 405b, respectively. The rotary member 410 includes an optical fiber collimator 411 and a ¼ wavelength plate 412 encased in a housing structure 413, in which the collimator 411 is coupled to an end of the PM fiber 405a. The fixed member 420 includes an optical fiber collimator 421 and a ¼ wavelength plate 422 encased in a housing structure 423, in which the collimator 421 is coupled to an end of the PM fiber 405b. The rotary member 410 and the fixed member 420 are interfaced such that they couple the PM fiber 405a connected to the rotary member 410 with the PM fiber 405b connected to the fixed member 420, in which the ¼ waveplate 422 is attached to the collimator 421 on the fixed member 420 and aligned at 45 degrees to the axes of the PM fiber 405b of the collimator 421 while the other ¼ waveplate 412 is attached to the collimator 411 on the rotary member 410 and aligned at 45 degrees to the axes of PM fiber 405a of the collimator 411.

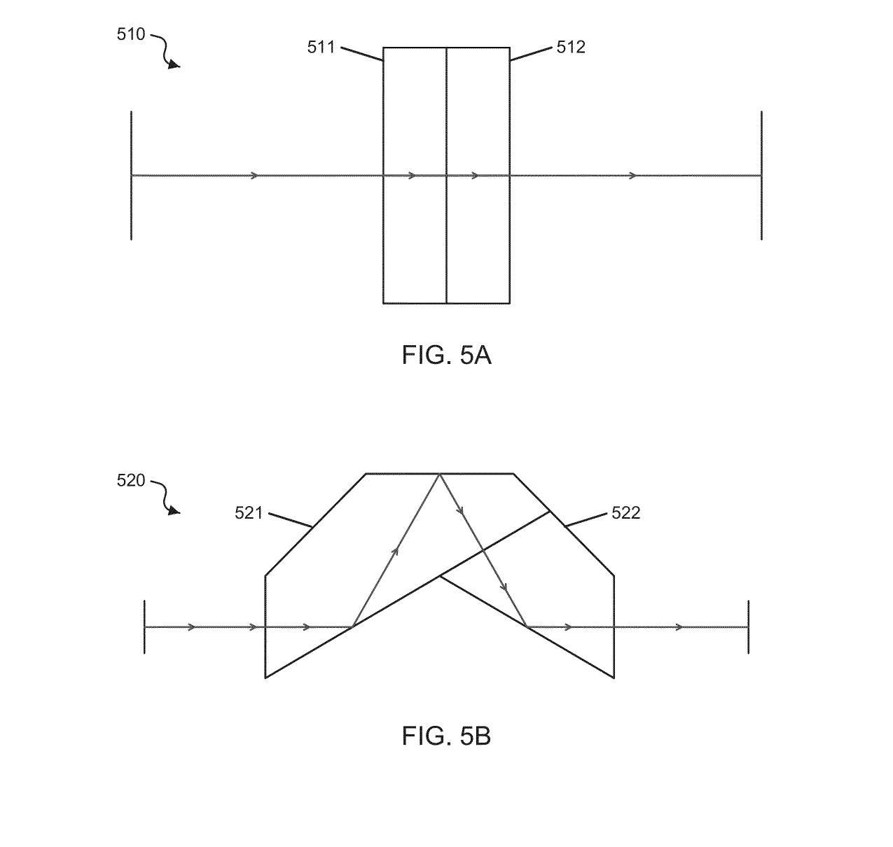

For example, the ¼ wavelength plates 412 and 422 of the PM ORJ 400 are substantially achromatic and the retardation types previously described can be modified to produce ¼ wavelength retardation. FIGS. 5A and 5B show two exemplary configurations of achromatic ¼ wavelength retarders that can be implemented in the PM ORJ 400. FIG. 5A shows a compound waveplate 510 including one ¼ waveplate 511 and one ½ waveplate 512 made of the same material with axes of the two waveplates oriented 60 degrees to each other. FIG. 5A shows a compound waveplate 520 including an achromatic ¼ waveplate 521 using retardation of internal reflections similar to standard Fresnel rhombs but with additional reflections so that input and output beams can be made collinear facilitating compactness of the rotary joint.

In another example, a polarization maintaining optical rotary joints that can be employed in the exemplary drive unit 200 is shown in FIG. 4B. FIG. 4B shows a PM ORJ 450 that includes a rotary member 460 capable of rotating about a fixed member 470, in which the rotary member 460 and the fixed member 470 are coupled to optical fibers 455a and 455b, respectively, e.g., which can be configured as PM fibers. The rotary member 460 includes an optical fiber collimator 461 encased in a housing structure 463, in which the collimator 461 is coupled to an end of the optical fiber 455a. The fixed member 470 includes an optical fiber collimator 471 encased in a housing structure 473, in which the collimator 471 is coupled to an end of the optical fiber 455b. The rotary member 460 and the fixed member 470 are interfaced such that they couple the optical fiber 455a connected to the rotary member 460 with the PM or non-PM optical fiber 455b connected to the fixed member 470. In this exemplary configuration, a dynamic polarization controller, which can be disposed anywhere between the source (e.g., swept source 110) and the PM optical rotary joint 450, controls the source state of polarization (SOP) of the fiber 455b connected to the static member in such way so that polarization is maintained in the rotating PM fiber 455a.

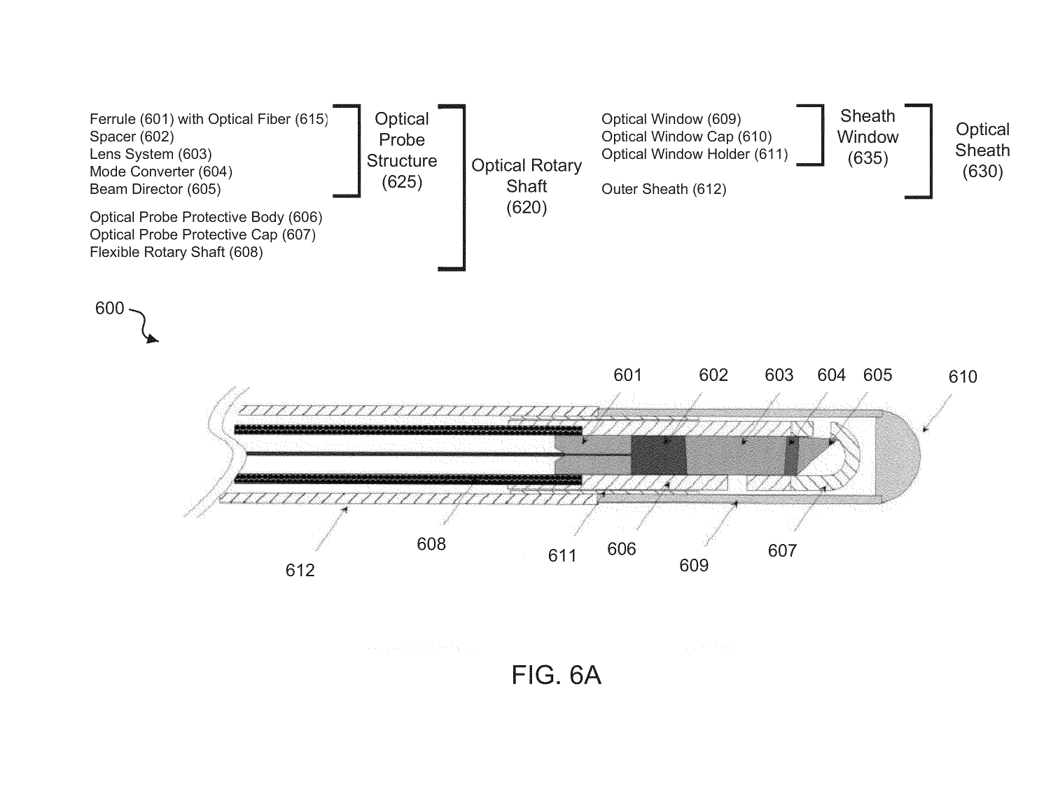

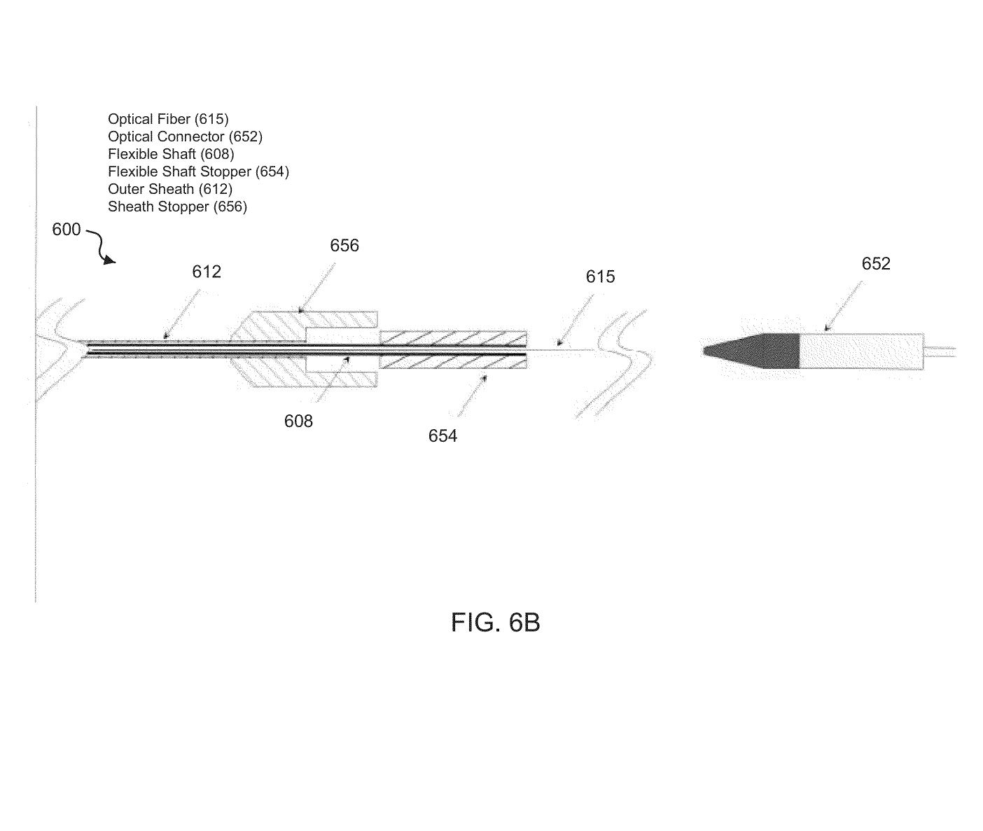

FIGS. 6A and 6B show schematics of the distal end and proximal end, respectively, of an exemplary disposable optical probe, e.g., such as a disposable catheter 600, that can be implemented as the imaging catheter unit of the probe with mode converter 180. The distal end of the exemplary disposable optical probe is the end positioned closest to the target to be imaged.

As shown in FIG. 6A, the disposable catheter 600 includes an optical rotary shaft 620 inserted in an optical sheath 630. The optical rotary shaft 620 can include an optical probe structure 625 inserted in a flexible rotary shaft 608 (which can be a hollow flexible rotary shaft) with a flexible shaft stopper 654 (shown in FIG. 6B) on the proximal end of the disposable catheter 600. The flexible shaft stopper 654 is structured to transfer torque from the drive unit 200 to the flexible shaft 608 of the optical rotary shaft 620 of the disposable catheter 600. For example, on the distal end, as shown in FIG. 6A, the hollow flexible shaft 608 may be directly attached to the optical probe structure 625 by adhesive or welding process or may be attached to an optical probe protective body 606. The optical probe protective body 606 can be in turn attached to the optical probe structure 625. The optical probe protective body 606 may further be interfaced with an optical probe protective cap 607 to facilitate insertion of the optical rotary shaft 620 into the optical sheath 630 during manufacturing.

As shown in FIG. 6A, the optical probe structure 625 can include an optical fiber ferrule 601 coupled to a spacer 602, which is coupled to a lens system 603, which is coupled to a mode converter 604, which is coupled to a beam director 605. The optical probe structure 625 can include a PM optical fiber inserted in the fiber ferrule 601, e.g., in which the fiber includes a partially reflective termination at the distal end so that some fraction of light will return in the same mode from this termination. The fiber ferrule 601 is followed by the spacer 602 (e.g., in the direction of light propagation from fiber to the tissue), then by a lens system 603 that focuses the transmitted fraction of light onto the tissue and collects the back-scattered light, the mode converter 604 that converts light from one mode to the other so that collected back-scattered light propagates in different propagation mode, and the light directing element (beam director 605) that direct light at the angle between 145° and 5° relative to rotational axis of the optical rotary shaft 620. The ferrule 601, the spacer 602, the lens system 603, the mode converter 604, and the beam director 605 can be bonded together, or, for example, at least some of the described elements can be bonded together, or they can be separately attached to the optical probe protective body 606, or any other separate housing structure. For example, the optical probe protective body 606 can encase and/or provide a protective support structure to the flexible rotary shaft 608 (e.g., near the interface with the optical fiber 601), the optical fiber 601, the spacer 602, the lens group 603, and at least a portion of the mode converter 604. The optical probe protective cap 607 can encase and/or provide a cover over the distal end of the beam director 605, in which the optical probe protective cap 607 interfaces with the optical probe protective body 606. At the proximal end, the PM optical fiber can be terminated with a standard fiber connector, e.g., such as a small form factor connector.

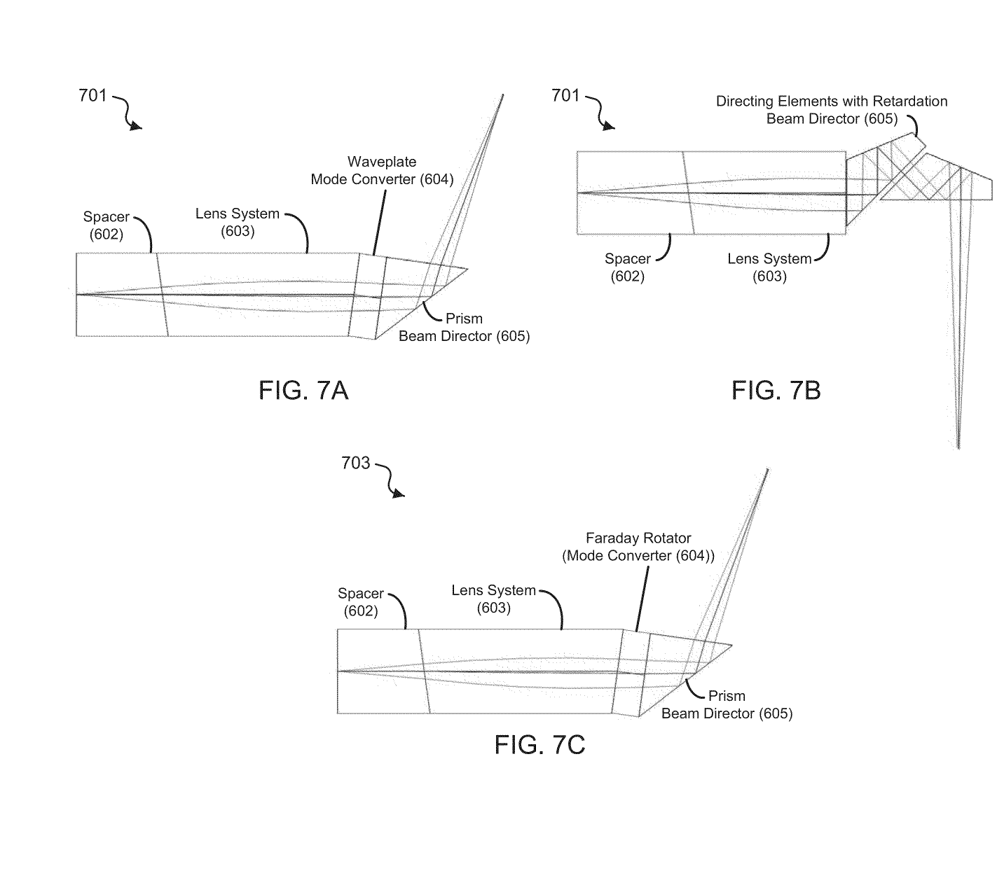

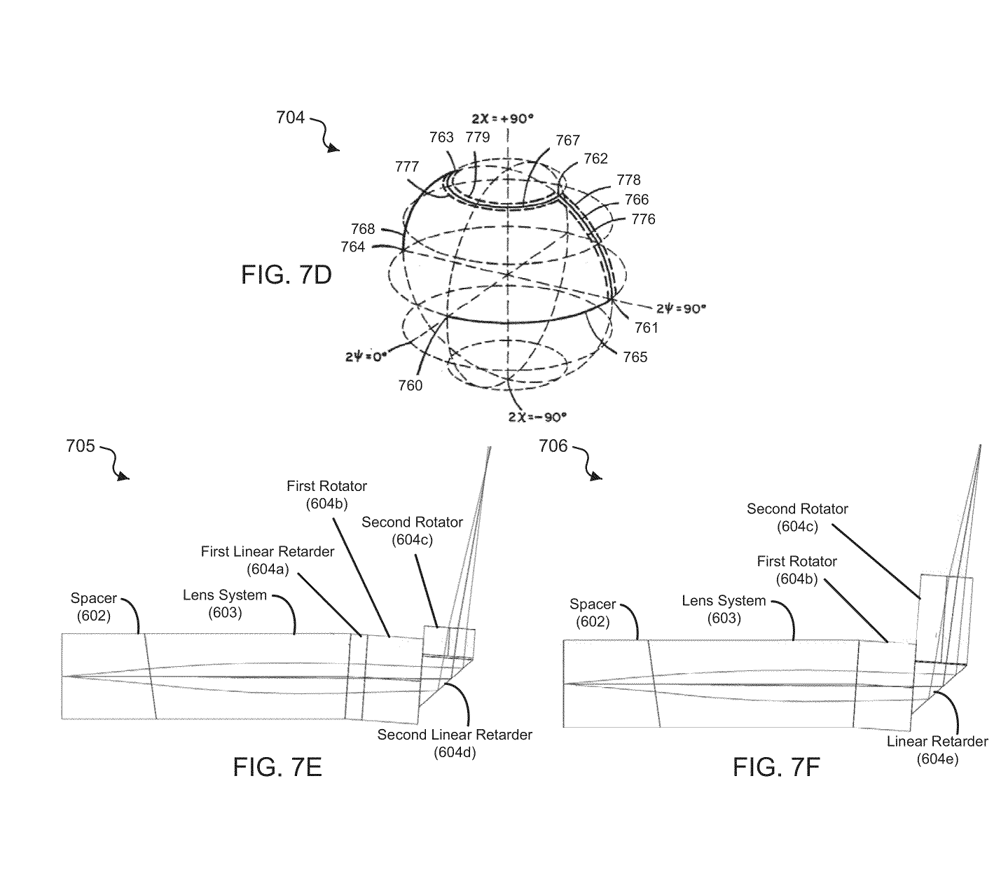

In some implementations, for example, the spacer 602 can be configured as a rod of high index material or, alternatively an air gap to obtain 0.1-5% fraction of reflected light back from the fiber termination. The spacer 602 can be configured to have one surface angle polished to minimize back-reflections for optimal sensitivity. For example, the lens system 603 can be configured as a GRIN lens with angle polished facets to minimize back-reflection from these surfaces. The lens system 603 can also be configured as other miniature standard lens with surface curvature or combination of GRIN lens and surface curvature known as C-lens, or any combination lenses. For example, the light directing element (beam director 605) can be configured as a prism utilizing at least one internal reflection from its surfaces, e.g., such as a 90 degree prism. The reflecting surface can also be coated with appropriate material to facilitate the reflection. The beam director 605 can also be configured as a deviation prism, e.g., such as a 20 degree prism. The beam director 605 can also be configured as a prism including a combination of reflective and deviating surfaces, or a combination of separate reflective and deviating surfaces. For example, a ¼ wavelength linear retarder with axes aligned 45° to the linear polarization orientation at the distal end of the optical fiber, or a non-reciprocal polarization rotator (e.g., also known as a Faraday rotator), can be implemented as the mode converter 604, e.g., provided that they are sufficiently achromatic and compact to be used in the optical probes. It is understood that location of the mode converter 604 is not critical for its operation, although generally, for example, the location between the lens system 603 and the light directing/deviating element is preferred. Exemplary configurations of the optical probe structure 625 with various configurations of mode converters are shown in FIGS. 7A-7F.

FIG. 7A shows a diagram 701 of an exemplary configuration of the optical probe structure 625 with the mode converter 604 configured in the form of waveplate made from birefringent material (e.g., such as quartz) of an appropriate thickness. The waveplate mode converter 604 is configured between the lens system 603 and the beam director 605, e.g., configures as a prism. For example, a directing element relying on reflection will have its own linear retardation. For example, the internal reflection of a 90 degree prism of BK7 glass produces ˜35° retardation between s and p polarizations. Therefore, the exemplary waveplate (configured as the mode converter 604) can have retardation such that combined retardation with the deviation element is 90 degrees. Alternatively, for example, the directing element may be aligned relative to the polarization state at the distal end of the optical fiber so that all reflections will be purely s or p reflections. It is understood that the waveplate 604 can be made of several pieces of birefringent material to make the waveplate substantially achromatic, e.g., as described previously.

FIG. 7B shows a diagram 702 of an exemplary configuration of the optical probe structure 625 in which the directing element(s) with retardation (e.g., beam director 605) act as a mode converter utilizing retardation effects upon internal Fresnel reflections, or reflection from coated surfaces. In this example, no additional waveplate is required. The directing element(s) with retardation 605 is configured at the distal end of the optical structure 625 coupled to the lens system 603. For example, with the practical selection of optical material, typically at least two reflections will be needed to acquire 90° retardation. It is understood that many prism configurations are possible that can have at least two reflections, e.g., in which the resulting is a total of 90° retardation.

FIG. 7C shows a diagram 703 of an exemplary configuration of the optical probe structure 625 with one 45 degree Faraday rotator configured as the mode converter 604. The location of the Faraday rotator is not critical. As shown in this example, the location of the Faraday rotator 604 is positioned after the lens system 603, e.g., which can produce better performance of such rotators with collimated light. An exemplary material that can be used for such rotators includes MGL Garnet, e.g., because it does not require external magnet resulting in compactness of the optical probe.

In another example, achromatic performance for polarization rotators can be achieved by combining non-reciprocal rotators of different lengths and linear retarders. For example, two rotators of different length with the opposite sense of rotation can be used with the ratio of two lengths being equal to cos X. Here, X represents the retardation angle of each of the two waveplate oriented at 45° relative to input polarization, as shown in FIG. 7D. For example, prisms with internal reflections in such achromatic polarization rotators can also be used, as described in U.S. Pat. No. 4,991,938 entitled “QUASI-ACHROMATIC OPTICAL ISOLATORS AND CIRCULATORS USING PRISMS WITH TOTAL INTERNAL FRESNEL REFLECTION”, which is incorporated by reference in its entirety as part of the disclosure of this patent document. FIG. 7D shows a Poincare sphere diagram 704 that represents the polarization transformation in a Faraday rotation element-linearly birefringent plate configuration, in terms of the spherical coordinates 2Ψ and 2χ, where Ψ is the orientation of the major elliptic axis and x is the ellipticity. The latter is the arc tangent of the elliptic axis ratio and is 45° for circularly polarized light. The radii of +90 and −180° arcs and arcs 765 and 767 of FIG. 7D are proportional to the cosines of their 2χ values which are 0° and 60° respectively. Since the radius of the −180° arc is half that of the +90° arc, the arc lengths are equal but opposite in sense. If the Faraday rotations that they represent each change by a proportional amount due to wavelength or temperature variations, the lengths of arcs 765 and 767 will both change by equal amounts. Arc 765 represents the nominal +45° Faraday rotation by element 755 from the input linear polarization state at point 760 to point 761. A change in its length causes the following 60° arc 766 which represents the transformation by plate 756 to move to a new position 776 or 778 while remaining centered about an equatorial axis through point 760. Both endpoints of arc 766 move by equal distances, and so the equal change in the length of arc 767 compensates that of arc 765, thereby leaving endpoint 763 of arc 767 representing the −90° Faraday rotation by element 757 invariant. Proportional changes in the retardations of plates 756 and 758 due to temperature or wavelength variations will cause the lengths of arcs 766 and 768 to change by equal amounts. These will cause arc 767 to move to a new position 777 or 779, but point 764 representing the linear output polarization state at an angle of +135° from the x axis will remain invariant. Output polarizer 759 is oriented at +135° to pass beam 752 undiminished in intensity.

FIG. 7E shows a diagram 705 of an exemplary configuration of the optical probe structure 625 with the mode converter 604 configured as an achromatic mode converter utilizing two polarization rotators and two linear retarders. In this exemplary configuration, a first polarization rotator 604b can be configured as a +90 degree Faraday rotator, which can be disposed after a first linear retarder 604a, e.g., the first linear retarder 604a of 60° retardation. The first linear retarder 604a can be a 60° retardation waveplate oriented 45° relative to the linear polarization state at the distal end of the optical fiber. A second polarization rotator 604c can be configured as a −45 degree Faraday rotator, which can be disposed after a second linear retarder 604d, e.g., the second linear retarder 604d of 60° retardation oriented the same way as the first retarder. The second linear retarder 604d can be configured as a prism with internal reflection producing 60° retardation or combination of a waveplate and the prism. It is understood that several more combination of two rotators and two waveplates are possible to achieve the achromatic performance of polarization rotation, as disclosed in U.S. Pat. No. 4,991,938.

FIG. 7F shows a diagram 706 of an exemplary configuration of the optical probe structure 625 with the mode converter 604 configured as an achromatic mode converter when the polarization rotation is not achromatic upon single pass through all the elements by the light, but achromatic upon double pass. In this exemplary configuration, only one linear retarder is required, e.g., linear retarder 604e, in which the directing element in the form of prism can be used as the linear retarder 604e. In this exemplary configuration, the first polarization rotator 604b can be configured as +90 degree Faraday rotator, followed by the directing element, e.g., the linear retarder 604e, producing approximately 48° retardation. There are many combinations of material and angle of incidence that can produce such retardation upon one reflection, for example, a 90 degree prism made of material with refractive index approximately equal to 1.58. The second polarization rotator 604c can be configured as a −135 degree Faraday rotator. It is understood that several more combination of two rotators and one linear retarder are possible to achieve the achromatic performance of mode converter of this type.

For example, another embodiment of the mode converter 604 can include a reflective film with quarter wavelength retardation properties deposited on hypotenuse of the directing element (prism). In addition to mode conversion function, such films can act as a reflective surface enabling operation of the directing element with immersion liquids, e.g., such as water or oil. One example of such film is an organic film is disclosed in U.S. Pat. No. 7,170,574 entitled “TRIM RETARDERS INCORPORATING NEGATIVE BIREFRINGENCE”, which is incorporated by reference in its entirety as part of the disclosure of this patent document.

Referring back to FIG. 6A, the optical sheath 630 can include an outer sheath 612 made of appropriate material and an optical sheath window 635 that be attached to the distal end of the outer sheath 612 with adhesive or with heat shrinking or fusion process. The sheath window 635 to encase and/or cover some of the distal components of the optical probe structure 625, e.g., which can include the beam director 605 and the components encased and/or supported by the optical probe protective body 606. The outer sheath 612 can be used to encase and/or cover the flexible rotary shaft 608. In some implementations, the optical sheath window 635 can be configured of multiple components, e.g., such as an optical window 609, an optical window cap 610 and an optical window holder 611. The optical window holder 611 can facilitate the attachment process of the sheath window 635 to the distal end of the outer sheath 612. The optical window cap 610 can be used to facilitate insertion of the disposable catheter 600, e.g., through a natural orifice or an incision into a body. It is also possible to have an integral optical element fabricated by molding that combines the functions of the optical window 609, optical window cap 610 and optical window holder 611 in one integral element. The outer sheath 612 can be made of transparent material so that the outer sheath itself acts as an optical window with no separate optical window required. The optical sheath 612 may also contain index matching liquid to minimize light back reflection. In this example, all the reflecting surfaces of the directing element in contact with the index matching liquid are metalized or sealed to ensure proper internal reflection.

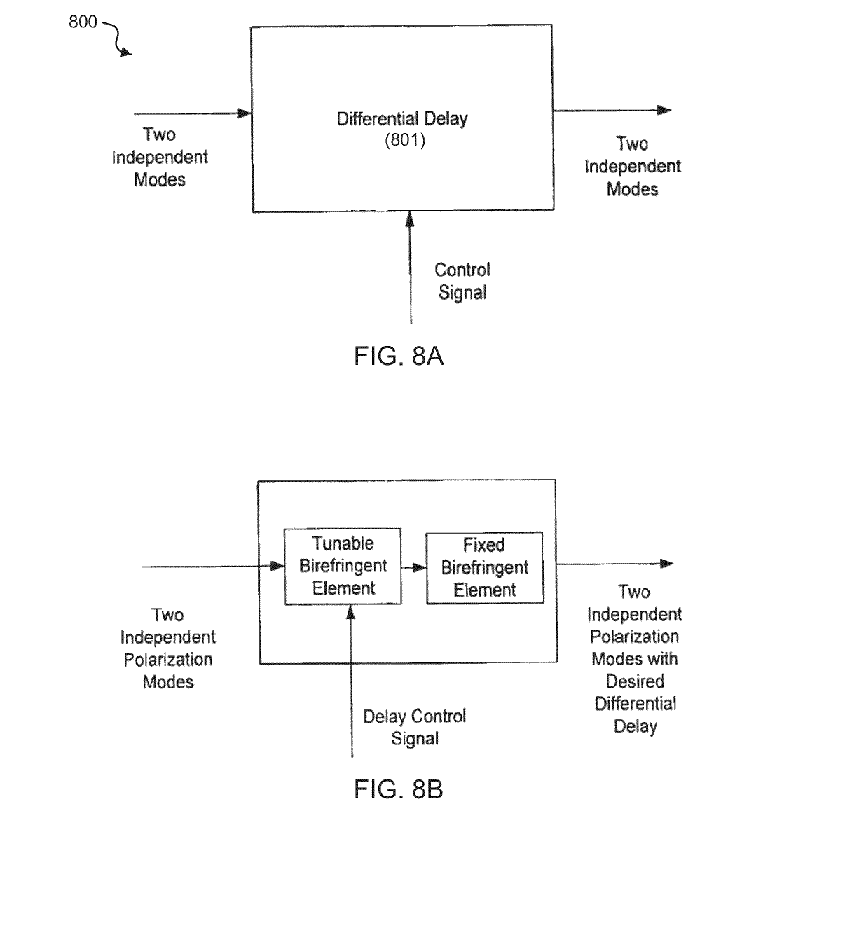

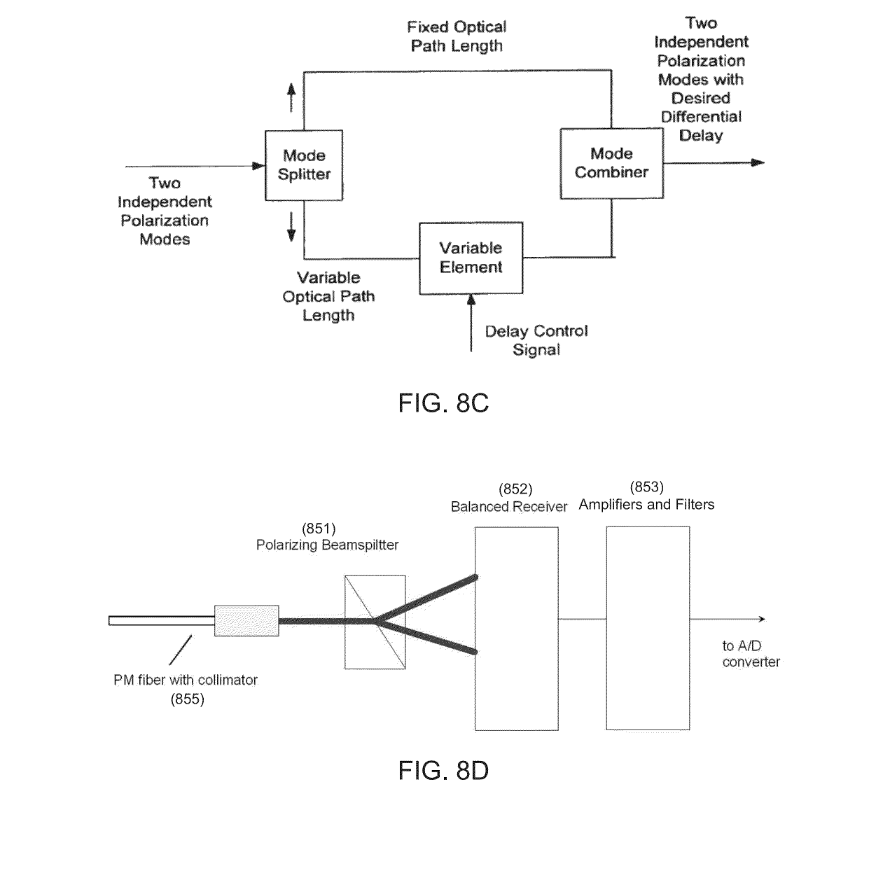

Referring back to FIG. 1A, the differential delay controller 140 can be used to change group delay between the two propagation modes 001 and 002 for optimal performance during application of an OFDI implementation. FIG. 8A shows one exemplary embodiment of the differential delay controller 140 as an optical differential delay modulator 800 in which an external control signal is applied to control a differential delay element 801 to change and modulate the relative delay in the output, as described in U.S. Pat. No. 6,943,881. The differential delay element 801 can be configured using mechanical or non-mechanical elements to produce the desired relative delay between the two modes and the modulation on the delay. In other examples, the differential delay controller 140 can be implemented using other differential group delay controller designs, for example, including those from General Photonics such as DynaDelay or ProDelay modules.

In one exemplary configuration of the optical differential delay modulator 800, a non-mechanical design of the differential delay element 801 may include one or more segments of tunable birefringent materials such as liquid crystal materials or electro-optic birefringent materials such as lithium niobate crystals in conjunction with one or more fixed birefringent materials such as quartz and rutile. The fixed birefringent material provides a fixed delay between two modes and the tunable birefringent material provides the tuning and modulation functions in the relative delay between the two modes. FIG. 8B illustrates an example of this non-mechanical design where the two modes are not physically separated and are directed through the same optical path with birefringent segments which alter the relative delay between two polarization modes.

In another exemplary configuration of the optical differential delay modulator 800, FIG. 8C shows a different design where the two modes in the received light are separated by a mode splitter into two different optical paths. A variable delay element is inserted in one optical path to adjust and modulate the relative delay in response to an external control signal. A mode combiner is then used to combine the two modes together in the output. The mode splitter and the mode combiner may be polarization beams splitters when two orthogonal linear polarizations are used as the two modes. The variable delay element in one of the two optical paths may be implemented in various-configurations. For example, the variable delay element may be a mechanical element. A mechanical implementation of the device in FIG. 8C may be constructed by first separating the radiation by polarization modes with a polarizing beam splitter, one polarization mode propagating through a fixed optical path while the other propagating through a variable optical path having a piezoelectric stretcher of polarization maintaining fibers, or a pair of collimators both facing a mechanically movable retroreflector in such a way that the light from one collimator is collected by the other through a trip to and from the retroreflector, or a pair collimators optically linked through double passing a rotatable optical plate and bouncing off a reflector.

The detection subsystem 150 functions by converting the back-scattered light from the tissue 199 into an electrical signal upon the mixing of propagation modes. The detection subsystem 150 can perform the mixing of the two propagation modes 001 and 002, converting the optical information into an electrical signal, and processing and filtering the electrical signal. FIG. 8D shows a schematic of an exemplary configuration of the detection subsystem 150. In this example, the detection subsystem 150 includes a polarization beamsplitter 851 as a propagation mode mixing element and a standard balanced optical receiver 852, e.g., which can include two optical detectors and subtraction, filtering, and amplification circuitry. In some implementations, the light entering the detection subsystem 150 can be inputted via a coupling including a PM fiber and collimator 855. In some implementations, the balanced receiver 852 can be followed by additional electrical amplifiers and filters 852, e.g., anti-aliasing filters. In this example, the polarizing beamsplitter 851 can be oriented to minimize a DC component of the signal at the output of the balanced receiver 852 to optimize sensitivity of OFDI. It is understood that any standard polarization beamsplitter and/or optical detectors can be used in the detection subsystem.

The controls and signal processing subsystem 160 can be used to synchronize the swept source wavelength tuning of the swept source 110, the rotation of the optical rotary shaft 620 within the disposable catheter 600, and analog-to-digital (A/D) conversion. The controls and signal processing subsystem 160 can then digitize the electrical signal provided by the detection subsystem 150 and then perform a discrete Fourier Transform (DFT) analysis and/or other digital signal processing (DSP) processes known in the field of OFDI.

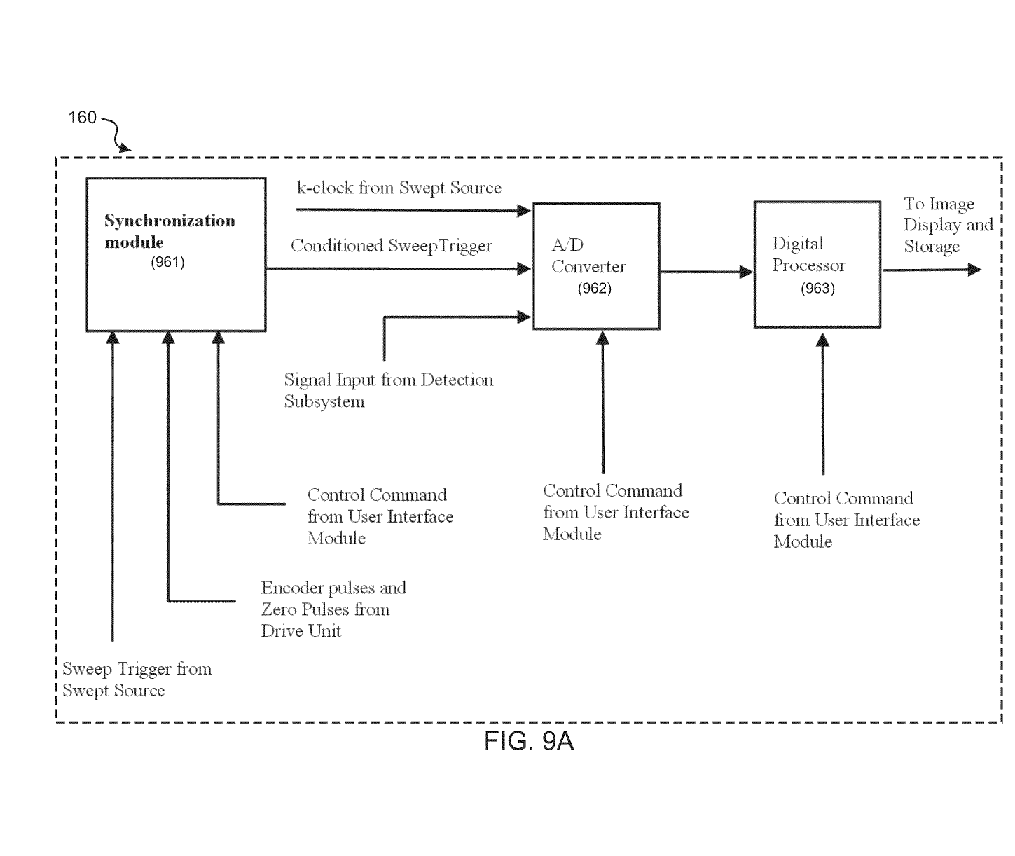

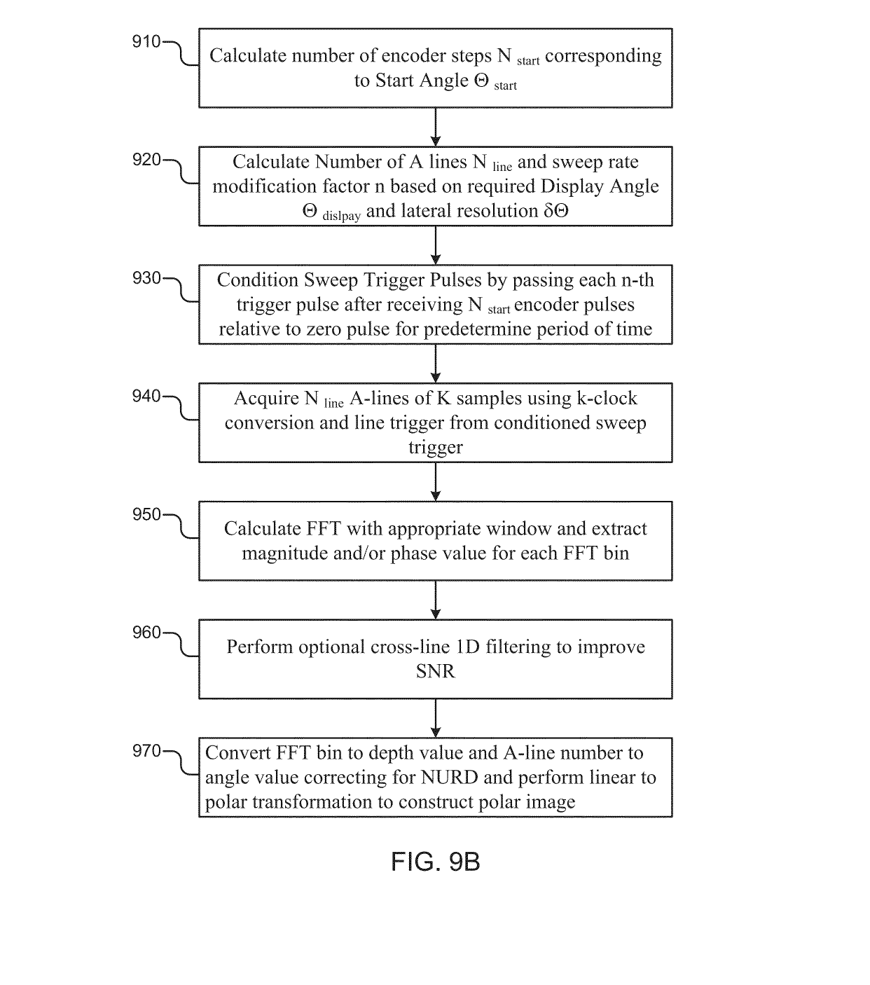

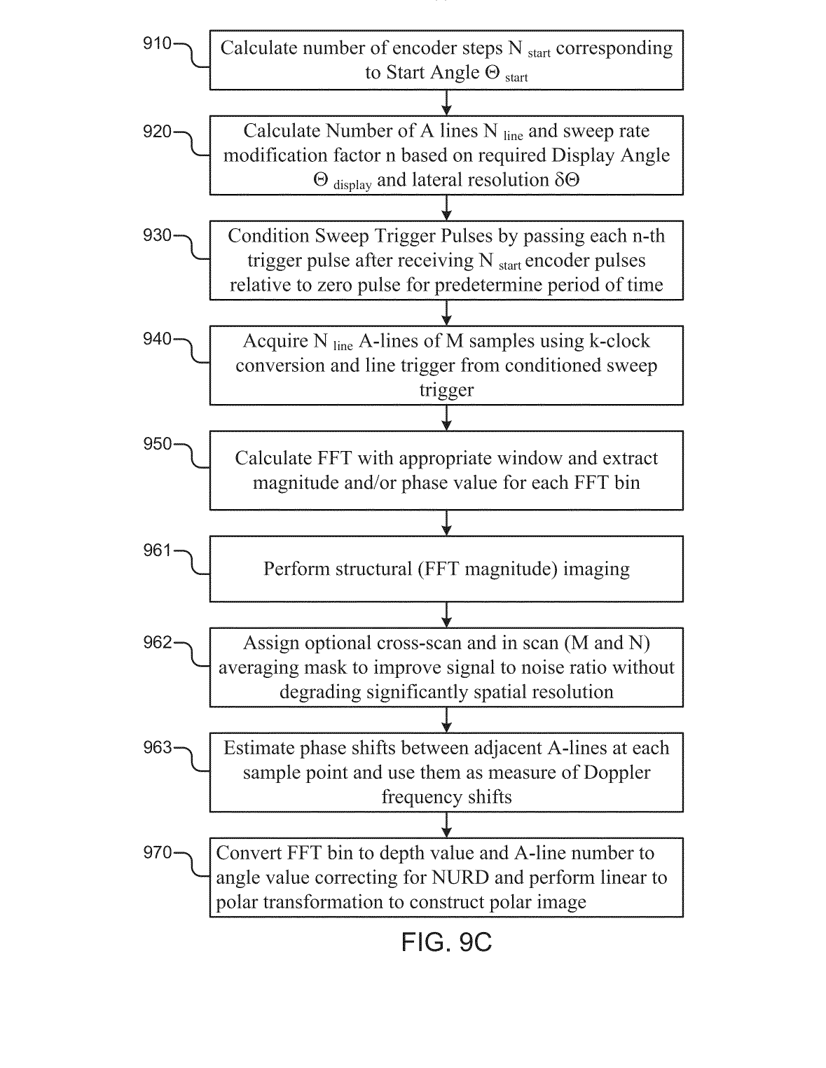

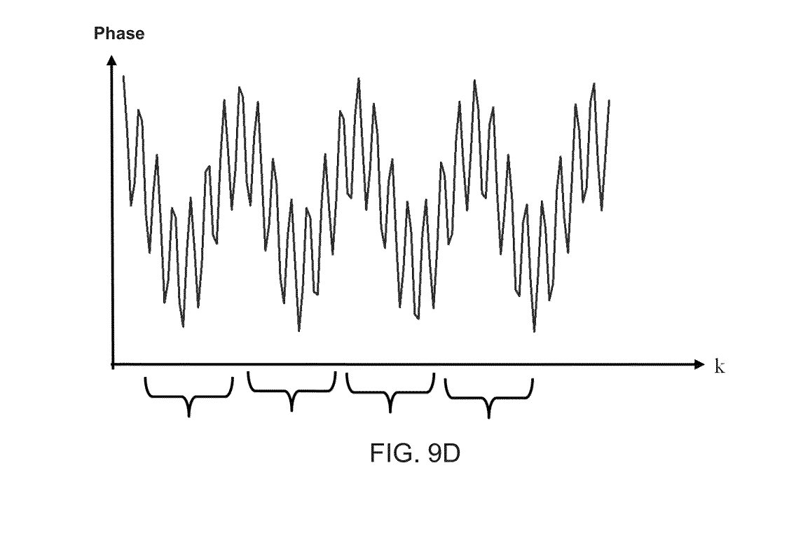

FIG. 9A shows a block diagram of an exemplary controls and signal processing subsystem 160. The controls and signal processing subsystem 160 can include a synchronization module 961 that receives a sweep trigger signal form the swept source 110, encoder pulses and zero pulses from the drive unit 200 of the probe with mode converter 180, and control command information from the main processor/display/storage/and user interface module 170. The synchronization module 961 synchronizes the inputted signals and outputs a conditioned sweep trigger signal to an A/D converter 962 of the controls and signal processing subsystem 160. The A/D converter 962 receives the k-clock signal from the swept source 110, signal input from the detection subsystem 150, and control command information from the main processor/display/storage/and user interface module 170. The A/D converter 962 converts these analog electrical signals into digital signals and outputs the digital signals to a digital processor 963 of the controls and signal processing subsystem 160. The digital processor 963 also receives control command information from the main processor/display/storage/and user interface module 170 and processes the digital signals to produce digital information (e.g., including image data) that is outputted to the main processor/display/storage/and user interface module 170, e.g., for image display and storage.

FIG. 9B shows a flow diagram of an exemplary process to operate the controls and signal processing subsystem 160. The process can be implemented to process the detected optical information measured from a sample (e.g., such as a biological tissue) and produce an image including structural, compositional, physiological and/or biological information from the information. The operation process can include a process 910 to calculate a number of encoder steps (Nₛₜₐᵣₜ) corresponding to a Start Angle (Θₛₜₐᵣₜ). The operation process can include a process 920 to calculate a number of A lines (Nₗᵢₙₑ) and sweep rate modification factor n based on required display angle (Θ_{display}) and lateral resolution δΘ. The operation process can include a process 930 to condition sweep trigger pulses by passing each n-th trigger pulse after receiving Nₛₜₐᵣₜ encoder pulses relative to zero pulse for predetermine period of time. The operation process can include a process 940 to acquire Nₗᵢₙₑ A-lines of K samples using k-clock conversion and line trigger from the conditioned sweep trigger. The operation process can include a process 950 to calculate a Fast Fourier Transform (FFT) with appropriate window and extract magnitude and/or phase values for each FFT bin. The operation process can include a process 960 to perform optional cross-line 1D filtering to improve SNR. The operation process can include a process 970 to convert FFT bin to depth value and A-line number to angle value correcting for non-uniform rotational distortion (NURD) and perform linear to polar transformation to construct polar image.

Disclosed are Doppler imaging processing techniques including signal processing steps for phase or optical Doppler imaging capable of depth-resolved imaging of blood flow in the systemic and pulmonary blood vessels. FIG. 9C shows a flow diagram of an exemplary process to operate the controls and signal processing subsystem 160, e.g., including sensitivity signal processing steps for Doppler and microangiography imaging. The operation process can include a process 910 to calculate a number of encoder steps (Nₛₜₐᵣₜ) corresponding to a Start Angle (Θₛₜₐᵣₜ). The operation process can include a process 920 to calculate a number of A lines (Nₗᵢₙₑ) and sweep rate modification factor n based on required display angle (Θ_{display}) and lateral resolution δΘ. The operation process can include a process 930 to condition sweep trigger pulses by passing each n-th trigger pulse after receiving Nₛₜₐᵣₜ encoder pulses relative to zero pulse for predetermine period of time. The operation process can include a process 940 to acquire Nₗᵢₙₑ A-lines of K samples using k-clock conversion and line trigger from the conditioned sweep trigger. The operation process can include a process 950 to calculate a Fast Fourier Transform (FFT) with appropriate window and extract magnitude and/or phase values for each FFT bin. The operation process can include a process 961 to perform structural FFT magnitude imaging. The operation process can include a process 962 to assign optional cross-scan and in-scan (M and N) averaging mask to improve the signal-to-noise ratio without degrading significantly spatial resolution. The operation process can include a process 963 to estimate phase shifts between adjacent A-lines at each sample point and use them as measure of Doppler frequency shifts. The operation process can include a process 970 to convert FFT bin to depth value and A-line number to angle value correcting for non-uniform rotational distortion (NURD) and perform linear to polar transformation to construct polar image.

In some implementations, the described hardware can be used to perform the disclosed Doppler imaging processing techniques including signal processing steps for phase or optical Doppler imaging. For example, directing elements (e.g., configured as the beam director 605 in the disposable catheter 600), such as prisms in the distal end of an exemplary imaging catheter or the probe should ensure incidence angle of light to the walls of imaging lumens deviating from zero. For example, the angle between the light emitting from the exemplar probe and the axis of the probe can be less than 90°. For example, in some configurations, the angle between the light emitting from the exemplar probe and the axis of the probe can be 75° to provide more efficient operation of Doppler imaging. Also, an exemplary mode controller 120 that includes the phase modulator to modulate the optical phase of light in one propagation mode relative to the other can be used to provide higher carrier frequency in interferograms to improve sensitivity of Doppler imaging. For example, as described in the process 961, 962, and 963 in FIG. 9B, flow sensitivity can be achieved by measuring the shift in the carrier frequency in the interferogram, e.g., due to backscattering of light from moving particles, or by comparing the phase of the interferogram from one A-line to the next.

In Doppler OCT systems, flow velocity is determined from Doppler frequency shift between the adjacent A-lines. There are several methods to estimate the flow velocity, e.g. including the Kasai autocorrelation estimator. The methods, as described by Mariampillai et al. in Optics Express 2007 Vol. 15, No. 4 pp. 1627-1630 and by Yang et al. in Optics Express 2003 Vol. 11 No. 7 pp. 794-809, in which both documents are incorporated by reference in their entirety as part of the disclosure of this patent document, can be adapted for the purpose of the disclosed technology and be used in all of the described embodiments of the disclosed imaging apparatuses, systems, and technology described herein.

The principle of velocity estimation is described. For example, consider a light source which emits a number N of discrete wave number kᵢ=k₀+iδk (i=1, 2, . . . , N) with k₀ for the starting wave number and δk for the wave number step. The interference signal current obtained by a balanced detector is represented by

Iᵢ=A cos [2(k₀+i∈k)(z₀+iυτₛ)] (1a)

where A is the amplitude of the interferogram, z₀ is the reflector location, υ is the flow velocity, and τₛ is the sampling time interval. The flow velocity can be determined by Doppler shifted frequency which can be estimated from the phase difference of the signal between the adjacent A line scans Δφ=2k_{c}υτ_{A}, where τ_{A}=Nτₛ is the time interval between the successive A-line scans. Kasai velocity estimator is an autocorrelation function between adjacent A-line phases which can be obtained as follows.

For example, the Fourier transformed OCT signal can be expressed as the complex number:

S=I+jQ (1b)

where I and Q are the in-phase and quadrature phase components of the signal, respectively. The mean flow velocity <υ> at any pixel can be evaluated as:

<υ>=λ_{c}f_{D}/2nₛ cos θ (1c)

where λ_{c}=2n/k_{c} is the center wavelength of the light source, nₛ is the refractive index of the sample, θ is the Doppler angle, and f_{D} is the Doppler shifted frequency which is represented using Kasai velocity estimator as:

$${f}_{D} = \frac{{f}_{A}}{2 π} arctan ( \frac{\frac{1}{M ( N - 1 )} {\sum }_{m = 1}^{M} {\sum }_{n = 1}^{N - 1} ( {I}_{m , n + 1} {Q}_{m , n} - {Q}_{m , n + 1} {I}_{m , n} )}{\frac{1}{M ( N - 1 )} {\sum }_{m = 1}^{M} {\sum }_{n = 1}^{N - 1} ( {Q}_{m , n + 1} {Q}_{m , n} - {I}_{m , n + 1} {I}_{m , n} )} ) \qquad ( 1 d )$$

where f_{A}=1/τ_{A} is the A-line scan rate and m and n are the axial and lateral indices. Kasai velocity estimator can be obtained by averaging pixels different in both axial and lateral positions, which causes the position blurring. The observable velocity range is restricted by aliasing limit of ±λ_{c}f_{A}/4nₛ.

For example, the Kasai autocorrelation function that measures phase shifts between two adjacent A-scans can be used to measure blood flow in the pulmonary vessels. More specifically the Kasai autocorrelation function measures phase shifts between two adjacent A-line, and is shown in Equation (1e).

$$Δϕ = arctan \{ \frac{{\sum }_{m = 1}^{M} {\sum }_{n = 1}^{N - 1} ( {I}_{n + 1} [ m ] {Q}_{n} [ m ] - {Q}_{n + 1} [ m ] {I}_{n} [ m ] )}{{\sum }_{m = 1}^{M} {\sum }_{n = 1}^{N - 1} ( {I}_{n + 1} [ m ] {Q}_{n} [ m ] + {Q}_{n + 1} [ m ] {I}_{n} [ m ] )} \} \qquad ( 1 e )$$

Here, M and N define the size of the averaging mask used to improve the signal-to-noise ratio and I, and Q represents the real and imaginary parts of the FFT signal. The phase shifts are proportional to tissue motion and represent blood flow in systemic and pulmonary blood vessels. The structural image (e.g., magnitude of the back scattered light) can be represented using the following function described in Equation (1f).

$$〈 {S}^{2} 〉 = {\sum }_{m = 1}^{M} {\sum }_{n = 1}^{N - 1} ( {I}_{n + 1}^{2} [ m ] - {I}_{n}^{2} [ m ] + {Q}_{n + 1}^{2} [ m ] - {Q}_{n}^{2} [ m ] ) \qquad ( 1 f )$$

In some implementations of the described flow sensitivity imaging techniques, the interferogram obtained by imaging apparatus can be split into different portions, as shown in FIG. 9D, and analyzed independently to determine phase shifts of the same A-line in different times. Exemplary advantages of this approach can include improved phase stability and increased signal to noise ratios and lateral resolution, e.g., but with a tradeoff including an exemplary disadvantage of loss in depth resolution.

In other embodiment of signal processing steps for Doppler or microangiography imaging, a broadening of phase shifts can be analyzed to measure the averaged blood flow or turbulence of blood flow due to microcirculation in capillaries. For example, the standard deviation of the phase shifts estimated by Kasai autocorrelation function can be used.

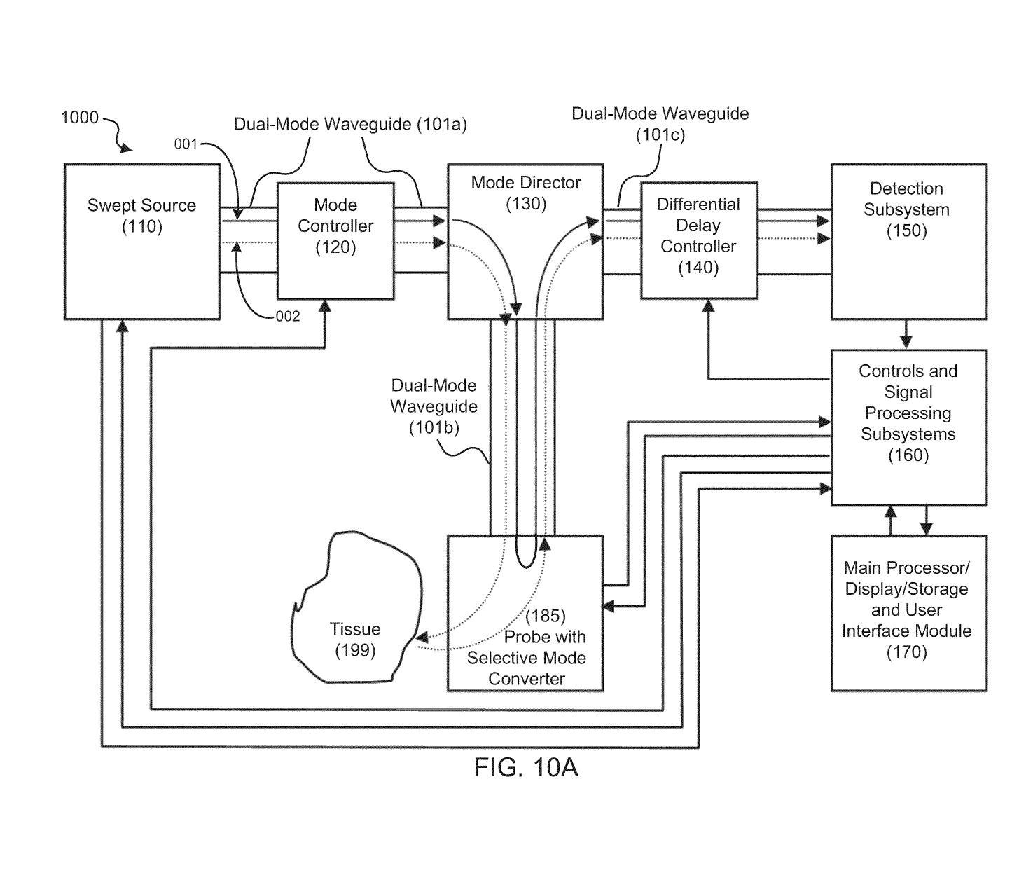

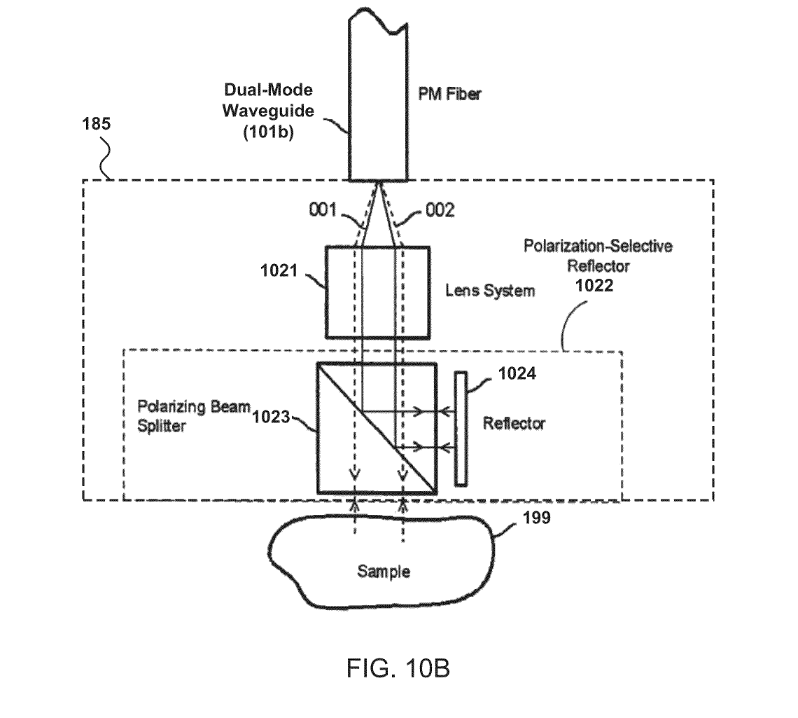

FIG. 10 shows an exemplary embodiment of an optical sensing device 1000 of the disclosed technology. The device 1000 can include many of the same components and operate in a similar manner as the device 100 to perform Doppler OCT imaging, e.g., including blood flow and blood oxygenation mapping and microangiography, except for the following differences. The device 1000 can be implemented to direct light in the two propagation modes 001 and 002 along the dual-mode waveguide 101 to an optical probe with selective mode converter component 185 positioned at or near the tissue sample 199 for acquiring information of optical inhomogeneity in the sample, e.g., including blood flow, oxygenation, and microangiography imaging. The probe with selective mode converter 185 can include an imaging catheter unit that is configured with a lens system 1021 and a polarization-selective reflector (PSR) 1022. FIG. 10B shows the interface between the dual-mode waveguide 101b and the probe with selective mode converter component 185, which includes a polarization selective reflector 1022, as described in U.S. Pat. No. 6,943,881, which is incorporated by reference in its entirety as part of the disclosure of this patent document. The lens system 1021 is to concentrate the light energy into a small area, facilitating spatially resolved studies of the sample in a lateral direction. The polarization-selective reflector 1022 reflects the mode 001 back and transmits the mode 002. Hence, the light in the mode 002 transmits through the probe head to impinge on the sample 199. Back reflected or scattered the light from the sample 199 is collected by the lens system 1021 to propagate towards the mode director 130 along with the light in the mode 001 reflected by PSR 1022 in the dual-mode waveguide 101b.

The PSR 1022 includes a polarizing beam splitter (PBS) 1023 and a reflector or mirror 1024 in a configuration as illustrated in FIG. 10B where the PBS 1023 transmits the selected mode (e.g., mode 002) to the sample 199 and reflects and diverts the other mode (e.g., mode 001) away from the sample 199 and to the reflector 1024. By retro reflection of the reflector 1024, the reflected mode 001 is directed back to the PBS 1023 and the lens system 1021. The reflector 1024 may be a reflective coating on one side of beam splitter 1023. The reflector 1024 should be aligned to allow the reflected radiation to re-enter the polarization-maintaining fiber 101. The transmitted light in the mode 002 impinges the sample 199 and the light reflected and back scattered by the sample 199 in the mode 002 transmits through the PBS 1023 to the lens system 1021. The lens system 1021 couples the light in both the modes 001 and 002 into the PM fiber dual-mode waveguide 101b.

An advantage of this embodiment of the device 1000 is ability to control the ratio of light power going to the sample by controlling the power ration between the two propagation modes 001 and 002 using the mode controller 120. Additionally, the device 1000 can be configured into a configuration that includes only one mode selectively being partially reflected from distal termination, and partially transmitted to the tissue 199. In this exemplary case, no separate mode mixing is required in the detection subsystem 150, and non-polarizing beamsplitters can be used for balanced detection.

For example, to enable further miniaturization of the selective mode reflectors such as miniature polarizing beamsplitter, a thin film polarizer can be implemented in this embodiment of the of the device 1000. In some implementations, a thin film polarizer suitable for the small imaging catheter unit can include a nano-structured material, e.g., such as a metal nano-wire grid including such by Nano-Opto. The exemplary nanowire-grid polarizer includes cores composed of silicon dioxide nanowalls with metal coating on one side. These cores are surrounded by multilayer thin films for antireflection. The core nanowire grid utilizes nano-sized high-aspect ratio dielectric walls as a support for forming a high aspect ratio metal nanowire grid, which significantly reduces energy loss due to metal absorption for the transmitted beam while achieving high extinction ratio for the blocked beam. The nanowire-grid structure can be fabricated by a wafer-based nanoreplication lithography and pattern-transfer techniques on miniature elements such fiber facets or grin lens facets.

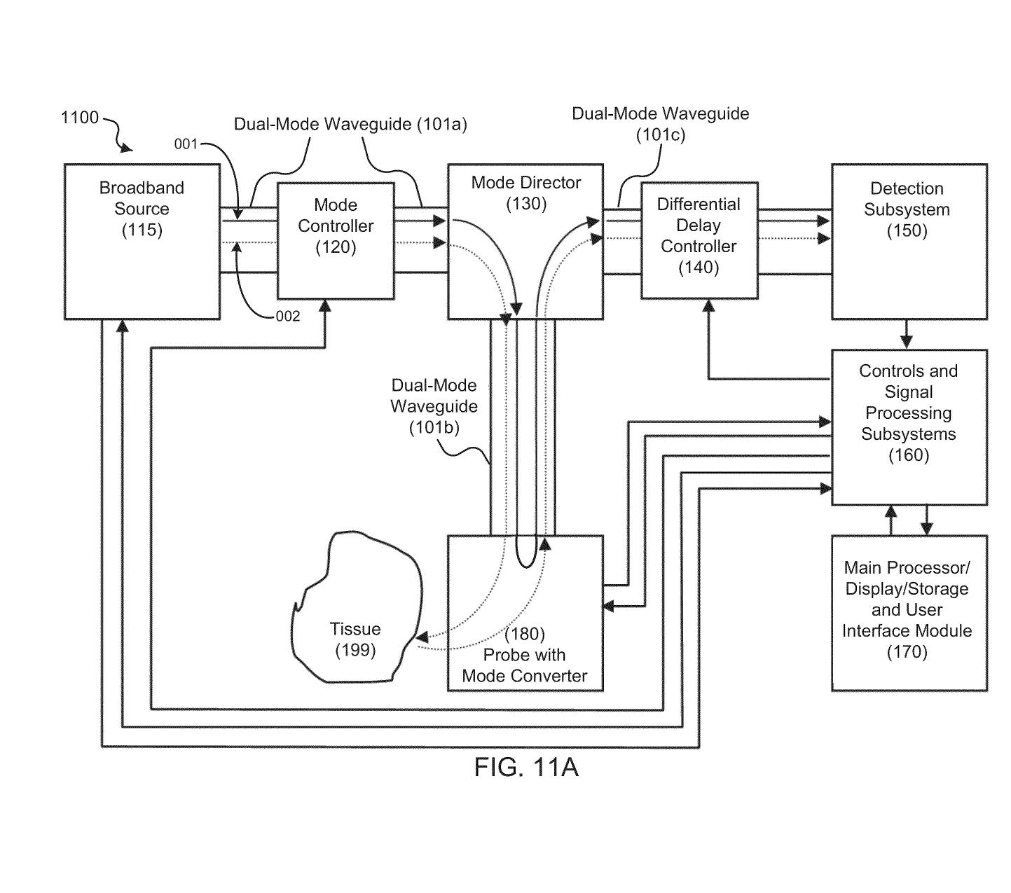

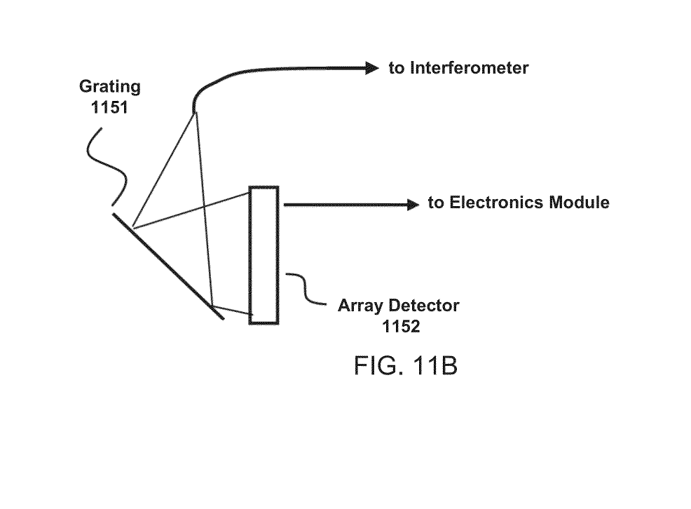

FIG. 11A shows another exemplary embodiment of an optical sensing device 1100 of the disclosed technology. The device 1100 can include many of the same components and operate in a similar manner as the device 100 to perform Doppler OCT imaging, except for the following differences. The device 1100 can be implemented to direct light generated by a broadband source 115 (e.g., instead of the swept source 110) in the two propagation modes 001 and 002 along the dual-mode waveguide 101 to the optical probe with mode converter 180 positioned at or near the tissue sample 199 for acquiring information of optical inhomogeneity in the sample. The light generated by the broad band source 115 can be generated without differential group delay, and the optical path difference between two propagation modes 001 and 002 can be kept substantially constant so that an interferogram can be obtained by dispersing spectral components of the interferometer output the detection subsystem 150.

FIG. 11B shows a diagram of the arrangement of an exemplary detection subsystem 150 of the device 1100. This arrangement of an exemplary detection subsystem 150 includes a grating component 1151 to obtain intensity of each spectral component with an array detector 1152, e.g., which can be used to replace the balanced optical receiver of the detection subsystem 150 shown in the FIG. 8D.

Additionally, for example, the controls and signal processing subsystems 160 of the device 1100 can differ from the configuration of the controls and signal processing subsystems 160 of the devices 100 or 1000. In one exemplary configuration, the controls and signal processing subsystems 160 of the device 1100 can be implemented without the need for k-clock synchronization, e.g., in which only the linear array detector read-outs, the rotation of the optical rotary shaft 620 within the disposable catheter 600 of the probe with mode converter 180, and the A/D conversion need to be synchronized.

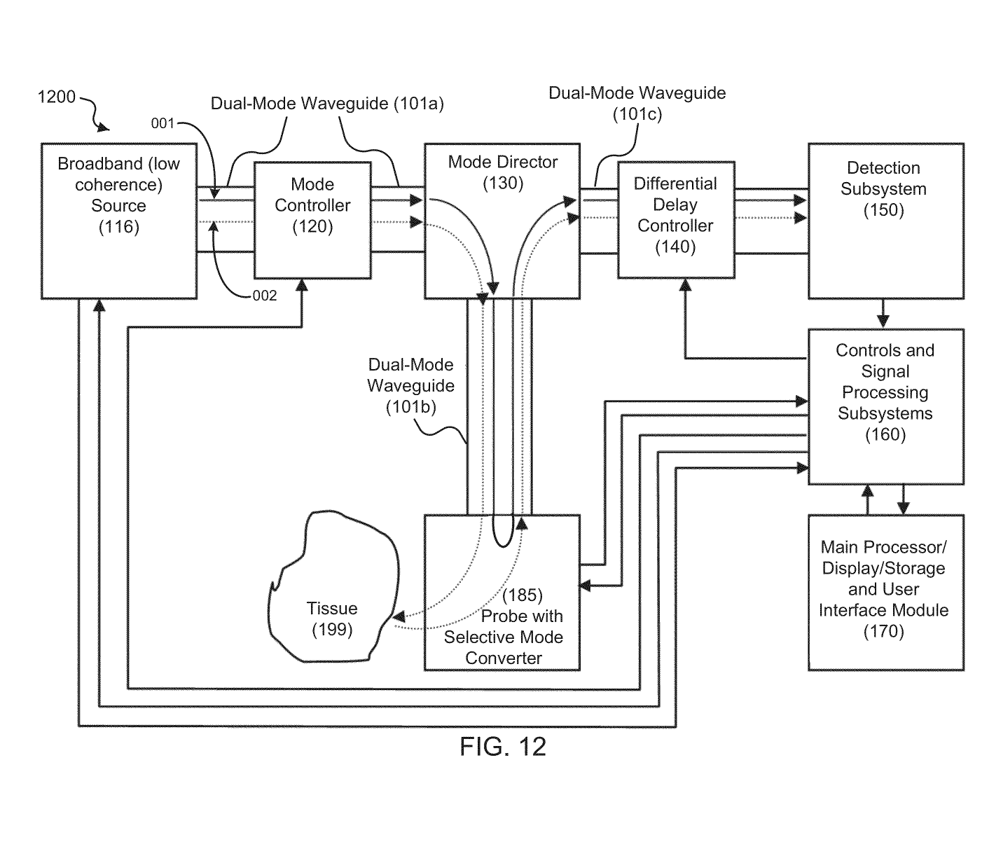

FIG. 12 shows other exemplary optical sensing device of the disclosed technology. The device 1200 can include many of the same components and operate in a similar manner as the device 100 to perform Doppler OCT imaging, except for the following differences. The device 1200 can be implemented to direct light generated by a broadband low coherence source 116 (e.g., instead of the swept source 110) in the two propagation modes 001 and 002 along the dual-mode waveguide 101 to the optical probe with selective mode converter 185 positioned at or near the tissue sample 199 for acquiring information of optical inhomogeneity in the sample. The light generated by the broad band low coherence source 116 can be generated without differential group delay, and the optical path difference between two propagation modes 001 and 002 can be kept substantially constant so that an interferogram can be obtained by dispersing spectral components of the interferometer output the detection subsystem 150.

Additionally, for example, the controls and signal processing subsystems 160 of the device 1200 can differ from the configuration of the controls and signal processing subsystems 160 of the devices 100 or 1000. In one exemplary configuration, the controls and signal processing subsystems 160 of the device 1200 can be implemented without the need for k-clock synchronization, e.g., in which only the linear array detector read-outs, the rotation of the optical rotary shaft 620 within the disposable catheter 600 of the probe with mode converter 180, and the A/D conversion need to be synchronized.

All of the disclosed embodiments of the optical sensing device of the disclosed technology, e.g., including the device 100, device 1000, device 1100, and the device 1200, can be adapted for spectral imaging (e.g., spectral imaging for blood oxygenation) by providing either broadband source that covers spectral band, as described in U.S. Pat. No. 7,831,298, and/or include a plurality of sources in different spectral band and use signal processing for spectral mapping, as described in U.S. Pat. No. 7,831,298.

Implementations of the subject matter and the functional operations described in this specification, such as various modules, can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this patent document.

What is claimed is:

1. A device for optically measuring a sample, comprising:
a swept light source to produce an input beam for optically probing a target area of a sample by sweeping an optical wavelength of the swept light source;
a waveguide having a proximal end to receive the input beam from the swept light source and a distal end towards which the received input beam is guided by the waveguide in two independent propagation modes propagating with different polarization states;
an optical probe coupled to the distal end of the waveguide to receive the input beam and to reflect a first portion of the input beam corresponding to a first propagation mode back to the waveguide and direct a second portion of the input beam corresponding to a second propagation mode to the sample, the optical probe configured to overlap reflection of the second portion from the sample with the first portion and to export to the waveguide the reflection as a reflected second portion;
a differential delay controller to receive light returned from the optical probe via the waveguide including the first portion and the reflected second portion, the differential delay controller operable to split the received light into a first beam corresponding to the first portion and a second beam corresponding to the reflected second portion and to produce variable relative phase delays between the first beam and the second beam;
a detection module to combine the first beam and the second beam that is outputted by the differential delay controller, the detection module operable to extract information of the sample carried by the reflected second portion at different depths in the sample based on the variable relative phase delays produced by the differential delay controller, and convert the extracted information to an electronic signal; and
a processing unit to process the electronic signal to produce optical images of the target area of the sample at different depths from a surface of the target area, and the processing unit configured to synchronize sweeping of the optical wavelength of the swept light source with the optical probe and detection module.

2. The device of claim 1, wherein the optical images include data including an oxygen exchange state in blood present at the target area to produce a map of blood oxygenation or blood flow within the target area.

3. The device of claim 1, wherein the swept light source includes a wavelength tunable coherent laser.

4. The device of claim 1, wherein the waveguide includes a polarization maintaining (PM) fiber.

5. The device of claim 1, wherein the sample includes biological tissue or organ including at least one of a lung, airways of a bronchial tree of the lung, blood vessels in the lung or other organ or body lumen, a gastrointestinal tract, a genital tract, or a urinary tract.

6. The device of claim 1, further comprising:
a light propagation mode director component coupled to the distal end of the waveguide and structured to include a polarization-maintaining optical circulator and three ports, the polarization-maintaining optical circulator to optically route the independent propagation modes of the input beam from a first port to a second port and optically route reflected light received at the second port to a third port;
a second waveguide having a proximal end to receive the independent propagation modes of the input beam from the second port and a distal end coupled to the optical probe towards which the independent propagation modes are guided by the second waveguide; and
a third waveguide having a proximal end to receive the reflected light from the third port and a distal end coupled to the differential delay controller to which the independent propagation modes are guided by the third waveguide.

7. The device of claim 1, further comprising:
a mode controller configured as an inline polarization controller along the waveguide that allows dynamic control of the relationship between amplitude and phase of the independent propagation modes of the input beam.

8. The device of claim 1, wherein the optical probe comprises:
a sheath structured to include a hollow channel along a sheath longitudinal direction, the sheath having a proximal end coupled to the distal end of the waveguide and configured to receive the input beam and a distal end configured to export the second portion of the input beam as probe light outside the sheath to the sample;
a polarization maintaining (PM) fiber movably placed inside the hollow channel of the sheath and structured to exhibit a first principal polarization direction and a second, orthogonal principal polarization direction, both substantially perpendicular to a longitudinal direction of the PM fiber;
an optical probe head located inside the sheath and engaged to a distal end of the PM fiber with a fixed orientation relative to the first principal polarization axis of the PM fiber to receive the input beam from the PM fiber, the optical probe head including:
an optical mode converter component to convert the probe light from one propagation mode to another such that back-scattered light collected by the optical probe head propagates back in the device in different propagation modes, and
a light directing element including a prism to direct the probe light at an angle relative to a rotational axis of the optical probe head,
wherein the optical probe head directs the probe light polarized in the first principal polarization direction to exit the optical probe head at a first exit angle with respect to the sheath longitudinal direction and the probe light polarized in the second principal polarization direction to exit the optical probe head at a second, different exit angle with respect to the sheath longitudinal direction, respectively; and
a rotation mechanism coupled to the optical probe head and operable to rotate the optical probe head inside the sheath about the sheath longitudinal direction to change a direction of light existing the optical probe head at the first exit angle and at the second exit angle.

9. The device of claim 8, wherein the optical probe head further comprises one or more lenses to receive light from the PM fiber and focus at least a fraction of the probe light onto the target area and collects the back-scattered light.

10. The device of claim 8, wherein the optical mode converter component is configured as at least one of a waveplate, one or more prisms providing retardation, a 45 degree Faraday rotator, an achromatic mode converter utilizing two polarization rotators and two linear retarders, or an achromatic mode converter utilizing two polarization rotators and one linear retarder.

11. The device of claim 1, wherein the differential delay controller comprises:
a beam splitter to separate the light returned from the optical probe via the waveguide into the first beam corresponding to the first portion along a first optical path and the second beam corresponding to the reflected second portion along a second optical path;
a variable optical delay element in one of the first and the second optical paths to cause the relative phase delays between the first light beam and the second light beam; and
a beam combiner to combine the first beam and the second beam to produce combined light.

12. The device of claim 1, wherein the detection module comprises:
a polarization beamsplitter to combine the independent propagation modes corresponding to the first and the second beams as a mixed optical signal; and
a balanced optical receiver including a plurality of optical detectors and subtraction, filtering, or amplification circuitry to convert the mixed optical signal to the electronic signal.

13. The device of claim 12, wherein the detection module further includes one or more electrical amplifiers and filters to amplify the electronic signal.

14. The device of claim 12, wherein the polarization beamsplitter is oriented to minimize a DC component of the electronic signal at the output of the balanced optical receiver.

15. The device of claim 1, wherein the optical probe comprises:
one or more lenses to focus at least a fraction of the received light received from the waveguide onto the target area; and
a polarizing beam splitter to receive the light from the lens and to produce the probe light, the polarizing beam splitter transmitting the probe light polarized in the first principal polarization direction at the first exit angle and reflecting the probe light polarized in the second principal polarization direction at the second exit angle, respectively.

16. A device for optically measuring a sample, comprising:
a broadband light source to produce an input beam of light for optically probing a target area of a sample;
a waveguide having a proximal end to receive the input beam from the broadband light source and a distal end towards which the received input beam is guided by the waveguide in two independent propagation modes propagating with different polarization states;
an optical probe coupled to the distal end of the waveguide to receive the input beam and to reflect a first portion of the input beam corresponding to a first propagation mode of the light back to the waveguide and direct a second portion of the input beam corresponding to a second propagation mode of the light to the sample, the optical probe configured to overlap reflection of the second portion from the sample with the first portion and to export to the waveguide the reflection as a reflected second portion;
a differential delay controller to receive light returned from the optical probe via the waveguide including the first portion and the reflected second portion, the differential delay controller operable to split the received light into a first beam corresponding to the first portion and a second beam corresponding to the reflected second portion and to produce variable relative phase delays between the first beam and the second beam;
a detection module to combine the first beam and the second beam that is outputted by the differential delay controller, the detection module operable to extract information of the sample carried by the reflected second portion at different depths in the sample based on the variable relative phase delays produced by the differential delay controller, and convert the extracted information to an electronic signal; and
a processing unit to process the electronic signal to produce optical images of the target area of the sample at different depths from a surface of the target area, and the processing unit configured to synchronize the optical probe and detection module.

17. The device of claim 16, wherein the optical images include data including an oxygen exchange state in blood present at the target area to produce a map of blood oxygenation or blood flow within the target area.

18. The device of claim 16, wherein the waveguide includes a polarization maintaining (PM) fiber.

19. The device of claim 16, wherein the sample includes biological tissue or organ including at least one of a lung, airways of a bronchial tree of the lung, blood vessels in the lung or other organ or body lumen, a gastrointestinal tract, a genital tract, or a urinary tract.

20. The device of claim 16, further comprising:
a light propagation mode director component coupled to the distal end of the waveguide and structured to include a polarization-maintaining optical circulator and three ports, the polarization-maintaining optical circulator to optically route the independent propagation modes of the input beam from a first port to a second port and optically route reflected light received at the second port to a third port;
a second waveguide having a proximal end to receive the independent propagation modes of the input beam from the second port and a distal end coupled to the optical probe towards which the independent propagation modes are guided by the second waveguide; and
a third waveguide having a proximal end to receive the reflected light from the third port and a distal end coupled to the differential delay controller to which the independent propagation modes are guided by the third waveguide.

21. The device of claim 16, further comprising:
a mode controller configured as an inline polarization controller along the waveguide that allows dynamic control of the relationship between amplitude and phase of the independent propagation modes of the input beam.

22. The device of claim 16, wherein the optical probe comprises:
a sheath structured to include a hollow channel along a sheath longitudinal direction, the sheath having a proximal end coupled to the distal end of the waveguide and configured to receive the input beam and a distal end configured to export the second portion of the input beam as probe light outside the sheath to the sample;
a polarization maintaining (PM) fiber movably placed inside the hollow channel of the sheath and structured to exhibit a first principal polarization direction and a second, orthogonal principal polarization direction, both substantially perpendicular to a longitudinal direction of the PM fiber;
an optical probe head located inside the sheath and engaged to a distal end of the PM fiber with a fixed orientation relative to the first principal polarization axis of the PM fiber to receive the input beam from the PM fiber, the optical probe head including:
an optical mode converter component to convert the probe light from one propagation mode to another such that back-scattered light collected by the optical probe head propagates back in the device in different propagation modes, and
a light directing element including a prism to direct the probe light at an angle relative to a rotational axis of the optical probe head,
wherein the optical probe head directs the probe light polarized in the first principal polarization direction to exit the optical probe head at a first exit angle with respect to the sheath longitudinal direction and the probe light polarized in the second principal polarization direction to exit the optical probe head at a second, different exit angle with respect to the sheath longitudinal direction, respectively; and
a rotation mechanism coupled to the optical probe head and operable to rotate the optical probe head inside the sheath about the sheath longitudinal direction to change a direction of light existing the optical probe head at the first exit angle and at the second exit angle.

23. The device of claim 22, wherein the optical probe head further comprises one or more lenses to receive light from the PM fiber and focus at least a fraction of the probe light onto the target area and collects the back-scattered light.

24. The device of claim 22, wherein the optical mode converter component is configured as at least one of a waveplate, one or more prisms providing retardation, a 45 degree Faraday rotator, an achromatic mode converter utilizing two polarization rotators and two linear retarders, or an achromatic mode converter utilizing two polarization rotators and one linear retarder.

25. The device of claim 1, wherein the differential delay controller comprises:
a beam splitter to separate the light returned from the optical probe via the waveguide into the first beam corresponding to the first portion along a first optical path and the second beam corresponding to the reflected second portion along a second optical path;
a variable optical delay element in one of the first and the second optical paths to cause the relative phase delays between the first light beam and the second light beam; and
a beam combiner to combine the first beam and the second beam to produce combined light.

26. The device of claim 16, wherein the detection module comprises:
a polarization beamsplitter to combine the independent propagation modes corresponding to the first and the second beams as a mixed optical signal; and
a balanced optical receiver including a plurality of optical detectors and subtraction, filtering, or amplification circuitry to convert the mixed optical signal to the electronic signal.

27. The device of claim 26, wherein the detection module further includes one or more electrical amplifiers and filters to amplify the electronic signal.

28. The device of claim 16, wherein the detection module comprises:
a polarization beamsplitter to combine the independent propagation modes corresponding to the first and the second beams as a mixed optical signal; and
a grating component to obtain the intensity of each spectral component of the mixed optical signal; and
an array detector to convert the mixed optical signal to the electronic signal using the intensity of the spectral components.

29. The device of claim 28, wherein the detection module further includes one or more electrical amplifiers and filters to amplify the electronic signal.

30. The device of claim 16, wherein the optical probe comprises:
one or more lenses to focus at least a fraction of the received light received from the waveguide onto the target area; and
a polarizing beam splitter to receive the light from the lens and to produce the probe light, the polarizing beam splitter transmitting the probe light polarized in the first principal polarization direction at the first exit angle and reflecting the probe light polarized in the second principal polarization direction at the second exit angle, respectively.
